(19) United States
(12) Patent Application Publication
(10) Pub. No.: US 2008/0274913 A1
(43) Pub. Date: Nov. 6, 2008

(54) Multiplex Array Useful for Assaying Protein-Protein Interaction

(75) Inventor: Kevin Lee, New York, NY (US)

Correspondence Address: INVITROGEN CORPORATION;C/O INTELLEVATE, P.O. BOX 52050, MINNEAPOLIS, MN, 55402, US

(73) Assignee: Invitrogen Corporation, Carlsbad (CA)

(21) Appl. No.: 11/915,689

(22) PCT Filed: May 30, 2006
(86) PCT No.: PCT/US2006/020810

§ 371 Date: Jun. 20, 2008

(30) Foreign Application Priority Data
May 27, 2005 (US) 60685565

(51) Int. Cl. C40B 40/02

(52) U.S. Cl. 506/14

(57) ABSTRACT

The described invention shows how multiple interactions between two proteins of interest can be determined by observing activation or lack thereof of intracellular proteins, following interaction of ligand and receptor.

### FIELD OF THE INVENTION

This invention relates to methods for determining interaction between molecules of interest. More particularly, it relates to determining if a particular substance referred to as the test compound modulates the interaction of two or more specific proteins of interest, via determining activation of a reporter gene in a cell, where the activation, or lack thereof, results from the modulation or its absence. The determination occurs using transformed or transfected cells, which are also a feature of the invention, as are the agents used to transform or transfect them. More particularly, the inventions relates to what will be referred to as “multiple arrays,” which permit an investigator to screen test compounds against a plurality of proteins, such as receptors, GPCRs in particular.

### BACKGROUND AND RELATED ART

The study of protein/protein interaction, as exemplified, e.g., by the identification of ligands for receptors, is an area of great interest. Even when a ligand or ligands for a given receptor are known, there is interest in identifying more effective or more selective ligands. GPCRs will be discussed herein as a non-exclusive example of a class of proteins which can be studied in this way.

The G-protein coupled receptors, or “GPCRs” hereafter, are the largest class of cell surface receptors known for humans. Among the ligands recognized by GPCRs are hormones, neurotransmitters, peptides, glycoproteins, lipids, nucleotides, and ions. They also act as receptors for light, odors, pheromones, and taste. Given these various roles, it is perhaps not surprising that they are the subject of intense research, seeking to identify drugs useful in various conditions. The success rate has been phenomenal. Indeed, Howard, et al., Trends Pharmacol. Sci., 22:132-140 (2001) estimate that over 50% of marketed drugs act on such receptors. “GPCRs” as used herein, refers to any member of the GPCR superfamily of receptors characterized by a seven-transmembrane domain (7TM) structure. Examples of these receptors include, but are not limited to, the class A or “rhodopsin-like” receptors; the class B or “secretin-like” receptors; the class C or “metabotropic glutamate-like” receptors; the Frizzled and Smoothened-related receptors; the adhesion receptor family or EGF-7TM/LNB-7TM receptors; adiponectin receptors and related receptors; and chemosensory receptors including odorant, taste, vomeronasal and pheromone receptors. As examples, the GPCR superfamily in humans includes but is not limited to those receptor molecules described by Vassilatis, et al., Proc. Natl. Acad. Sci. USA, 100:4903-4908 (2003); Takeda, et al., FEBS Letters, 520:97-101 (2002); Fredricksson, et al., Mol. Pharmacol., 63:1256-1272 (2003); Glusman, et al., Genome Res., 11:685-702 (2001); and Zozulya, et al., Genome Biol., 2:0018.1-0018.12 (2001), all of which are incorporated by reference.

The mechanisms of action by which GPCRs function has been explicated to some degree. In brief, when a GPCR binds a ligand, a conformational change results, stimulating a cascade of reactions leading to a change in cell physiology. It is thought that GPCRs transduce signals by modulating the activity of intracellular, heterotrimeric guanine nucleotide binding proteins, or “G proteins”. The complex of ligand and receptor stimulates guanine nucleotide exchange and dissociation of the G protein heterotrimer into α and βγ subunits.

Both the GTP-bound α subunit and the βγ dimer can act to regulate various cellular effector proteins, including adenylyl cyclase and phospholipase C (PLC). In conventional cell based assays for GPCRs, receptor activity is monitored by measuring the output of a G-protein regulated effector pathway, such as the accumulation of cAMP that is produced by adenylyl cyclase, or the release of intracellular calcium, which is stimulated by PLC activity.

Conventional G-protein based, signal transduction assays have been difficult to develop for some targets, as a result of two major issues.

First, different GPCRs are coupled to different G protein regulated signal transduction pathways, and G-protein based assays are dependent on knowing the G-protein specificity of the target receptor, or require engineering of the cellular system, to force coupling of the target receptor to a particular effect or pathway. Second, all cells express a large number of endogenous GPCRs, as well as other signaling factors. As a result, the effector pathways that are measured may be modulated by other endogenous molecules in addition to the target GPCR, potentially leading to false results.

Regulation of G-protein activity is not the only result of ligand/GPCR binding. Luttrell, et al., J. Cell Sci., 115:455-465 (2002), and Ferguson, Pharmacol. Rev., 53:1-24 (2001), both of which are incorporated by reference, review other activities which lead to termination of the GPCR signal. These termination processes prevent excessive cell stimulation, and enforce temporal linkage between extracellular signal and corresponding intracellular pathway.

In the case of binding of an agonist to GPCR, serine and threonine residues at the C terminus of the GPCR molecule are phosphorylated. This phosphorylation is caused by the GPCR kinase, or “GRK,” family. Agonist complexed, C-terminal phosphorylated GPCRs interact with arrestin family members, which “arrest” receptor signaling. This binding inhibits coupling of the receptor to G proteins, thereby targeting the receptor for internalization, followed by degradation and/or recycling. Hence, the binding of a ligand to a GPCR can be said to “modulate” the interaction between the GPCR and arrestin protein, since the binding of ligand to GPCR causes the arrestin to bind to the GPCR, thereby modulating its activity. Hereafter, when “modulates” or any form thereof is used, it refers simply to some change in the way the two proteins of the invention interact, when the test compound is present, as compared to how these two proteins interact, in its absence. For example, the presence of the test compound may strengthen or enhance the interaction of the two proteins, weaken it, inhibit it, or lessen it in some way, manner or form which can then be detected.

This background information has led to alternate methods for assaying activation and inhibition of GPCRs. These methods involve monitoring interaction with arresting. A major advantage of this approach is that no knowledge of G-protein pathways is necessary.

Oakley, et al., Assay Drug Dev. Technol., 1:21-30 (2002) and U.S. Pat. Nos. 5,891,646 and 6,110,693, incorporated by reference, describe assays where the redistribution of fluorescently labelled arrestin molecules in the cytoplasm to activated receptors on the cell surface is measured. These methods rely on high resolution imaging of cells, in order to measure arrestin relocalization and receptor activation. It will be recognized by the skilled artisan that this is a complex, involved procedure.

Various other U.S. patents and patent applications dealing with these points have issued and been filed. For example, U.S. Pat. No. 6,528,271 to Bohn, et al., deals with assays for screening for pain controlling medications, where the inhibitor of β-arrestin binding is measured. Published U.S. patent applications, such as 2004/0002119, 2003/0157553, 2003/0143626, and 2002/0132327, all describe different forms of assays involving GPCRs. Published application 2002/0106379 describes a construct which is used in an example which follows; however, it does not teach or suggest the invention described herein.

It is an object of the invention to develop a simpler assay for monitoring and/or determining modulation of specific protein/protein interactions, where the proteins include but are not limited to, membrane bound proteins, such as receptors, GPCRs in particular. How this is accomplished will be seen in the examples which follow.

### SUMMARY OF THE INVENTION

Thus, in accordance with the present invention, there is provided a method for determining if a test compound modulates a specific protein/protein interaction of interest comprising contacting said compound to a cell which has been transformed or transfected with (a) a nucleic acid molecule which comprises, (i) a nucleotide sequence which encodes said first test protein, (ii) a nucleotide sequence encoding a cleavage site for a protease or a portion of a protease, and (iii) a nucleotide sequence which encodes a protein which activates a reporter gene in said cell, and (b) a nucleic acid molecule which comprises, (i) a nucleotide sequence which encodes a second test protein whose interaction with said first test protein in the presence of said test compound is to be measured, and (ii) a nucleotide sequence which encodes a protease or a portion of a protease which is specific for said cleavage site, and determining activity of said reporter gene as a determination of whether said compound modulates said protein/protein interaction.

The first test protein may be a membrane bound protein, such as a transmembrane receptor, and in particular a GPCR. Particular transmembrane receptors include β2-adrenergic receptor (ADRB2), arginine vasopressin receptor 2 (AVPR2), serotonin receptor 1a (HTR1A), m2 muscarinic acetylcholine receptor (CHRM2), chemokine (C—C motif) receptor 5 (CCR5), dopamine D2 receptor (DRD2), kappa opioid receptor (OPRK), or α1a-adregenic receptor (ADRA1A) although it is to be understood that in all cases the invention is not limited to these specific embodiments. For example, molecules such as the insulin growth factor-1 receptor (IGF-1R), which is a tyrosine kinase, and proteins which are not normally membrane bound, like estrogen receptor 1 (ESR1) and estrogen receptors 2 (ESR2). The protease or portion of a protease may be a tobacco etch virus nuclear inclusion A protease. The protein which activates said reporter gene may be a transcription factor, such as tTA or GAL4. The second protein may be an inhibitory protein, such as an arrestin. The cell may be a eukaryote or a prokaryote. The reporter gene may be an exogenous gene, such as β-galactosidase or luciferase.

The nucleotide sequence encoding said first test protein may be modified to increase interaction with said second test protein. Such modifications include but are not limited to replacing all or part of the nucleotide sequence of the C-terminal region of said first test protein with a nucleotide sequence which encodes an amino acid sequence which has higher affinity for said second test protein than the original sequence. For example, the C-terminal region may be replaced by a nucleotide sequence encoding the C-terminal region of AVPR2, AGTRLI, GRPR, F2RL1, CXCR2/IL-8b, CCR4, or GRPR.

The method may comprise contacting more than one test compound to a plurality of samples of cells, each of said samples being contacted by one or more of said test compounds, wherein each of said cell samples have been transformed or transfected with the aforementioned nucleic acid molecules, and determining activity of reporter genes in said plurality of said samples to determine if any of said test compounds modulate a specific, protein/protein interaction. The method may comprise contacting each of said samples with one test compound, each of which differs from all others, or comprise contacting each of said samples with a mixture of said test compounds.

In another embodiment, there is provided a method for determining if a test compound modulates one or more of a plurality of protein interactions of interest, comprising contacting said test compound to a plurality of samples of cells, each of which has been transformed or transfected with (a) a first nucleic acid molecule comprising, (i) a nucleotide sequence which encodes a first test protein, a nucleotide sequence encoding a cleavage site for a protease, and (ii) a nucleotide sequence which encodes a protein which activates a reporter gene in said cell, (b) a second nucleic acid molecule which comprises, (i) a nucleotide sequence which encodes a second test protein whose interaction with said first test protein in the presence of said test compound of interest is to be measured, (ii) a nucleotide sequence which encodes a protease or a protease which is specific for said cleavage site, wherein said first test protein differs from other first test proteins in each of said plurality of samples, and determining activity of said reporter gene in at one or more of said plurality of samples as a determination of modulation of one or more protein interactions of interest

In these systems, which may be referred to as “multiplex arrays,” a substrate is provided, such as a multiwell plate, which provides receptacles or means for holding a plurality of different samples, as described supra. Each receptacle presents a different molecule as first test protein. Preferably, the first test protein is a receptor, and more preferably, it is a GPCR. It is to be understood, however, that it is not required that any of the receptors used in the multiplex array be GPCRs, nor is it required that if some GPCRs are used, all of the receptors used must be GPCRs.

Example 30, set forth infra, provides a thorough, but by no means inclusive list, of receptors which may be used in these multiplex arrays.

The multiplex arrays contain at least 5 receptacles, each of which presents a different, first test protein as described supra. More preferably, these multiple arrays contain at least 10 different receptors, and even more preferably, at least 25 different receptors. An especially preferred embodiment is a multiplex array presenting at least about 50 different test proteins, with the upper limit being defined simply by the number of test proteins chosen by the artisan. Especially preferred embodiments present from about 25 to about 200 different test proteins, even more preferably from about 50 to about 200 test proteins, and most preferably from about 50 to about 100 test proteins, such as receptors, GPCRs in particular.

The second test protein may be different in each sample or the same in each sample. All of said samples may be combined in a common receptacle, and each sample comprises a different pair of first and second test proteins. Alternatively, each sample may be tested in a different receptacle. The reporter gene in a given sample may differ from the reporter gene in other samples. The mixture of test compounds may comprise or be present in a biological sample, such as cerebrospinal fluid, urine, blood, serum, pus, ascites, synovial fluid, a tissue extract, or an exudate.

In yet another embodiment, there is provided a recombinant cell, transformed or transfected with (a) a nucleic acid molecule which comprises, (i) a nucleotide sequence which encodes said first test protein, (ii) a nucleotide sequence encoding a cleavage site for a protease or a portion of a protease, and (iii) a nucleotide sequence which encodes a protein which activates a reporter gene in said cell, and (b) a nucleic acid molecule which comprises, (i) a nucleotide sequence which encodes a second test protein whose interaction with said first test protein in the presence of said test compound is to be measured, and (ii) a nucleotide sequence which encodes a protease or a portion of a protease which is specific for said cleavage site.

One or both of said nucleic acid molecules may be stably incorporated into the genome of said cell. The cell also may have been transformed or transfected with said reporter gene. The first test protein may be a membrane bound protein, such as a transmembrane receptor, and in particular a GPCR. Particular transmembrane receptors include ADRB2, AVPR2, HTR1A, CHRM2, CCR5, DRD2, OPRK, or ADRA1A.

The protease or portion of a protease may be a tobacco etch virus nuclear inclusion A protease. The protein which activates said reporter gene may be a transcription factor, such as tTA or GAL4. The second protein may be an inhibitory protein. The cell may be a eukaryote or a prokaryote. The reporter gene may be an exogenous gene, such as β-galactosidase or luciferase. The nucleotide sequence encoding said first test protein may be modified to increase interaction with said second test protein, such as by replacing all or part of the nucleotide sequence of the C-terminal region of said first test protein with a nucleotide sequence which encodes an amino acid sequence which has higher affinity for said second test protein than the original sequence. The C-terminal region may be replaced by a nucleotide sequence encoding the C-terminal region of AVPR2, AGTRLI, GRPR, F2RL1, CXCR2/IL-8B, CCR4, or GRPR.

In still yet another embodiment, there is provided an isolated nucleic acid molecule which comprises, (i) a nucleotide sequence which encodes a test protein (ii) a nucleotide sequence encoding a cleavage site for a protease or a portion of a protease, and (iii) a nucleotide sequence which encodes a protein which activates a reporter gene in said cell. The test protein may be a membrane bound protein, such as is a transmembrane receptor. A particular type of transmembrane protein is a GPCR. Particular transmembrane receptors include ADRB2, AVPR2, HTR1A, CHRM2, CCR5, DRD2, OPRK, or ADRA1A. The protease or portion of a protease may be a tobacco etch virus nuclear inclusion A protease. The protein which activates said reporter gene may be a transcription factor, such as tTA or GAL4. As above, the invention is not to be viewed as limited to these specific embodiments.

In still a further embodiment, there is provided an expression vector comprising an isolated nucleic acid molecule which comprises, (i) a nucleotide sequence which encodes a test protein (ii) a nucleotide sequence encoding a cleavage site for a protease or a portion of a protease, and (iii) a nucleotide sequence which encodes a protein which activates a reporter gene in said cell, and further being operably linked to a promoter.

In still yet a further embodiment, there is provided an isolated nucleic acid molecule which comprises, (i) a nucleotide sequence which encodes a test protein whose interaction with another test protein in the presence of a test compound is to be measured, and (ii) a nucleotide sequence which encodes a protease or a portion of a protease which is specific for said cleavage site. The test protein may be an inhibitory protein, such as an arrestin.

Also provided is an expression vector comprising an isolated nucleic acid molecule which comprises, (i) a nucleotide sequence which encodes a test protein whose interaction with another test protein in the presence of a test compound is to be measured, and (ii) a nucleotide sequence which encodes a protease or a portion of a protease which is specific for said cleavage site, said nucleic acid further being operably linked to a promoter.

An additional embodiment comprises a fusion protein produced by expression of:
an isolated nucleic acid molecule which comprises, (i) a nucleotide sequence which encodes a test protein (ii) a nucleotide sequence encoding a cleavage site for a protease or a portion of a protease, and (iii) a nucleotide sequence which encodes a protein which activates a reporter gene in said cell, and further being operably linked to a promoter; or
an isolated nucleic acid molecule which comprises, (i) a nucleotide sequence which encodes a test protein whose interaction with another test protein in the presence of a test compound is to be measured, and (ii) a nucleotide sequence which encodes a protease or a portion of a protease which is specific for said cleavage site

In yet another embodiment, there is provided a test kit useful for determining if a test compound modulates a specific protein/protein interaction of interest comprising a separate portion of each of (a) a nucleic acid molecule which comprises, a nucleotide sequence which encodes said first test protein (i) a nucleotide sequence encoding a cleavage site for a protease or a portion of a protease, (ii) a nucleotide sequence which encodes a protein which activates a reporter gene in said cell, and (b) a nucleic acid molecule which comprises, (i) a nucleotide sequence which encodes a second test protein whose interaction with said first test protein in the presence of said test compound is to be measured, (ii) a nucleotide sequence which encodes a protease or a portion of a protease which is specific for said cleavage site, and container means for holding each of (a) and (b) separately from each other.

The first test protein may be a membrane bound protein, such as a transmembrane receptor. A particular type of transmembrane receptor is a GPCR. A particular transmembrane protein is a GPCR. Particular transmembrane receptors include ADRB2, AVPR2, HTR1A, CHRM2, CCR5, DRD2, OPRK, or ADRA1A. The protease or portion of a protease may be tobacco etch virus nuclear inclusion A protease. The protein which activates said reporter gene may be a transcription factor, such as tTA or GAL4. The second protein may be an inhibitory protein, such as an arrestin. The kit may further comprise a separate portion of an isolated nucleic acid molecule which encodes a reporter gene. The reporter gene may encode β-galactosidase or luciferase. The nucleotide sequence encoding said first test protein may be modified to increase interaction with said second test protein, such as by replacing all or part of the nucleotide sequence of the C-terminal region of said first test protein with a nucleotide sequence which encodes an amino acid sequence which has higher affinity for said second test protein than the original sequence. The nucleotide sequence of said C-terminal region may be replaced by a nucleotide sequence encoding the C-terminal region of AVPR2, AGTRLI, GRPR, F2RL1, CXCR2/IL-8B, CCR4, or GRPR.

It is contemplated that any method or composition described herein can be implemented with respect to any other method or composition described herein. The use of the word “a” or “an” when used in conjunction with the term “comprising” in the claims and/or the specification may mean “one,” but it is also consistent with the meaning of “one or more,” “at least one,” and “one or more than one.”

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1 shows the conceptual underpinnings of the invention, pictorially, using ligand-receptor binding as an example.

FIGS. 2a and 2b show that the response of targets in assays in accordance with the invention is dose dependent, both for agonists and antagonists.

FIG. 3 shows that a dose response curve results with a different target and a different agonist as well.

FIG. 4 depicts results obtained in accordance with the invention, using the D2 dopamine receptor.

FIGS. 5a and 5b illustrate results of an assay which shows that two molecules can be studied simultaneously.

FIG. 6 sets forth the result of another “multiplex” assay, i.e., one where two molecules are studied simultaneously.

FIG. 7 presents data obtained from assays measuring EGFR activity.

FIG. 8 presents data obtained from assays in accordance with the invention, designed to measure the activity of human type I interferon receptor.

FIG. 9 elaborates on the results in FIG. 7, showing a dose response curve for IFN-α in the cells used to generate FIG. 7.

FIG. 10 shows the results of additional experiments where a different transcription factor, and a different cell line, were used.

FIGS. 11A-J present the results of experiments showing that the invention set forth herein can be used to categorize receptors into alpha or beta classes.

### DETAILED DESCRIPTION OF PREFERRED EMBODIMENTS

The present invention relates to methods for determining if a substance of interest modulates interaction of a first test protein, such as a membrane bound protein, like a receptor, e.g., a transmembrane receptor, with a second test protein, like a member of the arrestin family. The methodology involves cotransforming or cotransfecting a cell, which may be prokaryotic or eukaryotic, with two constructs. The first construct includes, a sequence encoding (i) the first test protein, such as a transmembrane receptor, (ii) a cleavage site for a protease, and (iii) a sequence encoding a protein which activates a reporter gene. The second construct includes, (i) a sequence which encodes a second test protein whose interaction with the first test protein is measured and/or determined, and (ii) a nucleotide sequence which encodes a protease or a portion of a protease sufficient to act on the cleavage site that is part of the first construct. In especially preferred embodiments, these constructs become stably integrated into the cells.

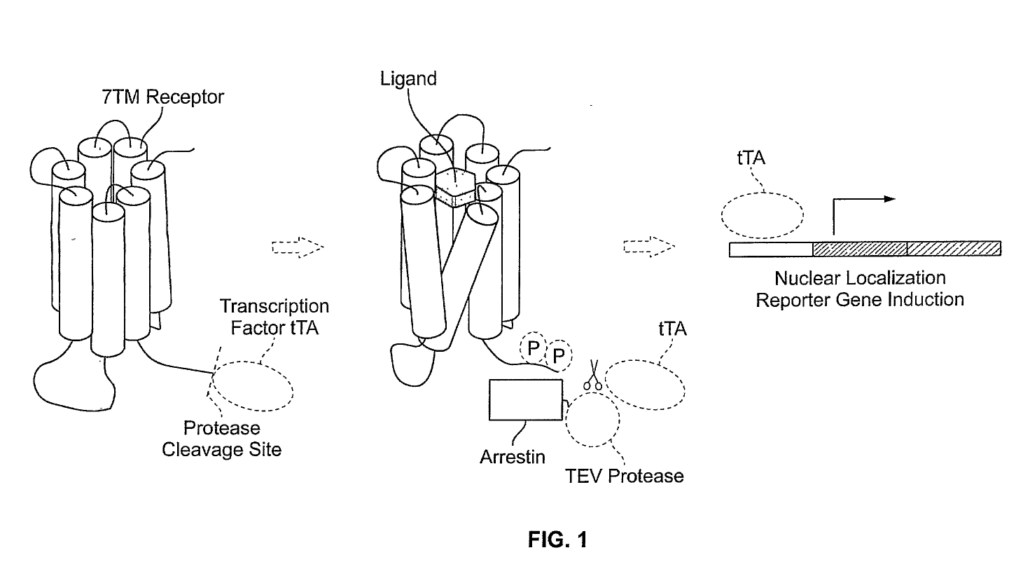

The features of an embodiment of the invention are shown, pictorially, in FIG. 1. In brief, first, standard techniques are employed to fuse DNA encoding a transcription factor to DNA encoding a first test protein, such as a transmembrane receptor molecule, being studied. This fusion is accompanied by the inclusion of a recognition and cleavage site for a protease not expressed endogenously by the host cell being used in the experiments.

DNA encoding this first fusion protein is introduced into and is expressed by a cell which also contains a reporter gene sequence, under the control of a promoter element which is dependent upon the transcription factor fused to the first test protein, e.g., the receptor. If the exogenous protease is not present, the transcription factor remains tethered to the first test protein and is unable to enter the nucleus to stimulate expression of the reporter gene.

Recombinant techniques can also be used to produce a second fusion protein. In the depicted embodiment, DNA encoding a member of the arrestin family is fused to a DNA molecule encoding the exogenous protease, resulting in a second fusion protein containing the second test protein, i.e., the arrestin family member.

An assay is then carried out wherein the second fusion protein is expressed, together with the first fusion protein, and a test compound is contacted to the cells, preferably for a specific length of time. If the test compound modulates interaction of the two test proteins, e.g., by stimulating, promoting or enhancing the association of the first and second test proteins, this leads to release of the transcription factor, which in turn moves to the nucleus, and provokes expression of the reporter gene. The activity of the reporter gene is measured.

In an alternative system, the two test proteins may interact in the absence of the test compound, and the test compound may cause the two test proteins to dissociate, lessen or inhibit their interaction. In such a case, the level of free, functionally active transcription factor in the cell decreases in the presence of the test compound, leading to a decrease in proteolysis, and a measurable decrease in the activity of the reporter gene.

In the depicted embodiment, the arrestin protein, which is the second test protein, binds to the receptor in the presence of an agonist; however, it is to be understood that since receptors are but one type of protein, the assay is not dependent upon the use of receptor molecules, nor is agonist binding the only interaction capable of being involved. Any protein will suffice, although the interest in transmembrane proteins is clear. Further, agonist binding to a receptor is not the only type of binding which can be assayed. One can determine antagonists, per se and also determine the relative strengths of different antagonists and/or agonists in accordance with the invention.

Other details of the invention, include specific methods and technology for making and using the subject matter thereof, are described below.

### I. EXPRESSION CONSTRUCTS AND TRANSFORMATION

The term “vector” is used to refer to a carrier nucleic acid molecule into which a nucleic acid sequence can be inserted for introduction into a cell where it can be replicated. A nucleic acid sequence can be “exogenous,” which means that it is foreign to the cell into which the vector is being introduced or that the sequence is homologous to a sequence in the cell but in a position within the host cell nucleic acid in which the sequence is ordinarily not found. Vectors include plasmids, cosmids, viruses (bacteriophage, animal viruses, and plant viruses), and artificial chromosomes (e.g., YACs). One of skill in the art would be well equipped to construct a vector through standard recombinant techniques (see, for example, Maniatis, et al., Molecular Cloning, A Laboratory Manual (Cold Spring Harbor, 1990) and Ausubel, et al., 1994, Current Protocols In Molecular Biology (John Wiley & Sons, 1996), both incorporated herein by reference).

The term “expression vector” refers to any type of genetic construct comprising a nucleic acid coding for a RNA capable of being transcribed. In some cases, RNA molecules are then translated into a protein, polypeptide, or peptide. In other cases, these sequences are not translated, for example, in the production of antisense molecules or ribozymes. Expression vectors can contain a variety of “control sequences,” which refer to nucleic acid sequences necessary for the transcription and possibly translation of an operably linked coding sequence in a particular host cell. In addition to control sequences that govern transcription and translation, vectors and expression vectors may contain nucleotide sequences that serve other functions as well and are described infra.

In certain embodiments, a plasmid vector is contemplated for use to in cloning and gene transfer. In general, plasmid vectors containing replicon and control sequences which are derived from species compatible with the host cell are used in connection with these hosts. The vector ordinarily carries a replication site, as well as marking sequences which are capable of providing phenotypic selection in transformed cells. In a non-limiting example, E. coli is often transformed using derivatives of pBR322, a plasmid derived from an E. coli species. pBR322 contains genes for ampicillin and tetracycline resistance and thus provides easy means for identifying transformed cells. The pBR plasmid, or other microbial plasmid or phage must also contain, or be modified to contain, for example, promoters which can be used by the microbial organism for expression of its own proteins. In addition, phage vectors containing replicon and control sequences that are compatible with the host microorganism can be used as transforming vectors in connection with these hosts. For example, the phage lambda GEM™-11 may be utilized in making a recombinant phage vector which can be used to transform host cells, such as, for example, E. coli LE392.

Bacterial host cells, for example, E. coli, comprising the expression vector, are grown in any of a number of suitable media, for example, LB. The expression of the recombinant protein in certain vectors may be induced, as would be understood by those of skill in the art, by contacting a host cell with an agent specific for certain promoters, e.g., by adding IPTG to the media or by switching incubation to a higher temperature. After culturing the bacteria for a further period, generally of between 2 and 24 h, the cells are collected by centrifugation and washed to remove residual media.

Many prokaryotic vectors can also be used to transform eukaryotic host cells. However, it may be desirable to select vectors that have been modified for the specific purpose of expressing proteins in eukaryotic host cells. Expression systems have been designed for regulated and/or high level expression in such cells. For example, the insect cell/baculovirus system can produce a high level of protein expression of a heterologous nucleic acid segment, such as described in U.S. Pat. Nos. 5,871,986 and 4,879,236, both herein incorporated by reference, and which can be bought, for example, under the name MAXBAC® 2.0 from INVITROGEN® and BACPACK™ BACULOVIRUS EXPRESSION SYSTEM FROM CLONTECH®.

Other examples of expression systems include STRATAGENE®'S COMPLETE CONTROL™ Inducible Mammalian Expression System, which involves a synthetic ecdysone-inducible receptor, or its pET Expression System, an E. coli expression system. Another example of an inducible expression system is available from INVITROGEN®, which carries the T-REX™ (tetracycline-regulated expression) System, an inducible mammalian expression system that uses the full-length CMV promoter. INVITROGEN® also provides a yeast expression system called the Pichia methanolica Expression System, which is designed for high-level production of recombinant proteins in the methylotrophic yeast Pichia methanolica. One of skill in the art would know how to express a vector, such as an expression construct, to produce a nucleic acid sequence or its cognate polypeptide, protein, or peptide.

Regulatory Signals

The construct may contain additional 5′ and/or 3′ elements, such as promoters, poly A sequences, and so forth. The elements may be derived from the host cell, i.e., homologous to the host, or they may be derived from distinct source, i.e., heterologous.

A “promoter” is a control sequence that is a region of a nucleic acid sequence at which initiation and rate of transcription are controlled. It may contain genetic elements at which regulatory proteins and molecules may bind, such as RNA polymerase and other transcription factors, to initiate the specific transcription a nucleic acid sequence. The phrases “operatively positioned,” “operatively linked,” “under control,” and “under transcriptional control” mean that a promoter is in a correct functional location and/or orientation in relation to a nucleic acid sequence to control transcriptional initiation and/or expression of that sequence.

A promoter generally comprises a sequence that functions to position the start site for RNA synthesis. The best known example of this is the TATA box, but in some promoters lacking a TATA box, such as, for example, the promoter for the mammalian terminal deoxynucleotidyl transferase gene and the promoter for the SV40 late genes, a discrete element overlying the start site itself helps to fix the place of initiation. Additional promoter elements regulate the frequency of transcriptional initiation. Typically, these are located in the region 30-110 bp upstream of the start site, although a number of promoters have been shown to contain functional elements downstream of the start site as well. To bring a coding sequence “under the control of” a promoter, one positions the 5′ end of the transcription initiation site of the transcriptional reading frame “downstream” of (i.e., 3′ of) the chosen promoter. The “upstream” promoter stimulates transcription of the DNA and promotes expression of the encoded RNA.

The spacing between promoter elements frequently is flexible, so that promoter function is preserved when elements are inverted or moved relative to one another. In the tk promoter, the spacing between promoter elements can be increased to 50 bp apart before activity begins to decline. Depending on the promoter, it appears that individual elements can function either cooperatively or independently to activate transcription. A promoter may or may not be used in conjunction with an “enhancer,” which refers to a cis-acting regulatory sequence involved in the transcriptional activation of a nucleic acid sequence.

A promoter may be one naturally associated with a nucleic acid molecule, as may be obtained by isolating the 5′ non-coding sequences located upstream of the coding segment and/or exon. Such a promoter can be referred to as “endogenous.” Similarly, an enhancer may be one naturally associated with a nucleic acid molecule, located either downstream or upstream of that sequence. Alternatively, certain advantages will be gained by positioning the coding nucleic acid segment under the control of a recombinant or heterologous promoter, which refers to a promoter that is not normally associated with a nucleic acid molecule in its natural environment. A recombinant or heterologous enhancer refers also to an enhancer not normally associated with a nucleic acid molecule in its natural environment. Such promoters or enhancers may include promoters or enhancers of other genes, and promoters or enhancers isolated from any other virus, or prokaryotic or eukaryotic cell, and promoters or enhancers not “naturally occurring,” i.e., containing different elements of different transcriptional regulatory regions, and/or mutations that alter expression. For example, promoters that are most commonly used in recombinant DNA construction include the β-lactamase (penicillinase), lactose and tryptophan (trp) promoter systems. In addition to producing nucleic acid sequences of promoters and enhancers synthetically, sequences may be produced using recombinant cloning and/or nucleic acid amplification technology, including PCR™, in connection with the compositions disclosed herein (see U.S. Pat. Nos. 4,683,202 and 5,928,906, each incorporated herein by reference). Furthermore, it is contemplated the control sequences that direct transcription and/or expression of sequences within non-nuclear organelles such as mitochondria, chloroplasts, and the like, can be employed as well.

Naturally, it will be important to employ a promoter and/or enhancer that effectively directs the expression of the DNA segment in the organelle, cell type, tissue, organ, or organism chosen for expression. Those of skill in the art of molecular biology generally know the use of promoters, enhancers, and cell type combinations for protein expression, (see, for example Sambrook, et al., 1989, incorporated herein by reference). The promoters employed may be constitutive, tissue-specific, inducible, and/or useful under the appropriate conditions to direct high level expression of the introduced DNA segment, such as is advantageous in the large-scale production of recombinant proteins and/or peptides. The promoter may be heterologous or endogenous.

Additionally any promoter/enhancer combination (as per, for example, the Eukaryotic Promoter Data Base EPDB, www.epd.isb-sib.ch/) could also be used to drive expression. Use of a T3, T7 or SP6 cytoplasmic expression system is another possible embodiment. Eukaryotic cells can support cytoplasmic transcription from certain bacterial promoters if the appropriate bacterial polymerase is provided, either as part of the delivery complex or as an additional genetic expression construct.

A specific initiation signal also may be required for efficient translation of coding sequences. These signals include the ATG initiation codon or adjacent sequences. Exogenous translational control signals, including the ATG initiation codon, may need to be provided. One of ordinary skill in the art would readily be capable of determining this and providing the necessary signals. It is well known that the initiation codon must be “in-frame” with the reading frame of the desired coding sequence to ensure translation of the entire insert. The exogenous translational control signals and initiation codons can be either natural or synthetic. The efficiency of expression may be enhanced by the inclusion of appropriate transcription enhancer elements.

In certain embodiments of the invention, the use of internal ribosome entry sites (IRES) elements are used to create multigene, or polycistronic, messages. IRES elements are able to bypass the ribosome scanning model of 5′ methylated Cap dependent translation and begin translation at internal sites (Pelletier and Sonenberg, Nature, 334:320-325 (1988)). IRES elements from two members of the picornavirus family (polio and encephalomyocarditis) have been described (Pelletier and Sonenberg, supra), as well an IRES from a mammalian message (Macejak and Sarnow, Nature, 353:90-94 (1991))1991). IRES elements can be linked to heterologous open reading frames. Multiple open reading frames can be transcribed together, each separated by an IRES, creating polycistronic messages. By virtue of the IRES element, each open reading frame is accessible to ribosomes for efficient translation. Multiple genes can be efficiently expressed using a single promoter/enhancer to transcribe a single message (see U.S. Pat. Nos. 5,925,565 and 5,935,819, each herein incorporated by reference).

Other Vector Sequence Elements

Vectors can include a multiple cloning site (MCS), which is a nucleic acid region that contains multiple restriction enzyme sites, any of which can be used in conjunction with standard recombinant technology to digest the vector (see, for example, Carbonelli, et al., FEMS Microbiol. Lett., 172(1):75-82 (1999), Levenson, et al., Hum. Gene Ther. 9(8):1233-1236 (1998), and Cocea, Biotechniques, 23(5):814-816 (1997)), incorporated herein by reference.) “Restriction enzyme digestion” refers to catalytic cleavage of a nucleic acid molecule with an enzyme that functions only at specific locations in a nucleic acid molecule. Many of these restriction enzymes are commercially available. Use of such enzymes is widely understood by those of skill in the art. Frequently, a vector is linearized or fragmented using a restriction enzyme that cuts within the MCS to enable exogenous sequences to be ligated to the vector. “Ligation” refers to the process of forming phosphodiester bonds between two nucleic acid fragments, which may or may not be contiguous with each other. Techniques involving restriction enzymes and ligation reactions are well known to those of skill in the art of recombinant technology.

Most transcribed eukaryotic RNA molecules will undergo RNA splicing to remove introns from the primary transcripts. Vectors containing genomic eukaryotic sequences may require donor and/or acceptor splicing sites to ensure proper processing of the transcript for protein expression (see, for example, Chandler, et al., 1997, herein incorporated by reference).

The vectors or constructs of the present invention will generally comprise at least one termination signal. A “termination signal” or “terminator” comprises a DNA sequence involved in specific termination of an RNA transcript by an RNA polymerase. Thus, in certain embodiments a termination signal that ends the production of an RNA transcript is contemplated. A terminator may be necessary in vivo to achieve desirable message levels.

In eukaryotic systems, the terminator region may also comprise specific DNA sequences that permit site-specific cleavage of the new transcript so as to expose a polyadenylation site. This signals a specialized endogenous polymerase to add a stretch of about 200 adenosine residues (polyA) to the 3′ end of the transcript. RNA molecules modified with this polyA tail appear to more stable and are translated more efficiently. Thus, in other embodiments involving eukaryotes, it is preferred that that terminator comprises a signal for the cleavage of the RNA, and it is more preferred that the terminator signal promotes polyadenylation of the message. The terminator and/or polyadenylation site elements can serve to enhance message levels and to minimize read through from the cassette into other sequences.

Terminators contemplated for use in the invention include any known terminator of transcription described herein or known to one of ordinary skill in the art, including but not being limited to, for example, the termination sequences of genes, such as the bovine growth hormone terminator, viral termination sequences, such as the SV40 terminator. In certain embodiments, the termination signal may be a lack of transcribable or translatable sequence, such as an untranslatable/untranscribable sequence due to a sequence truncation.

In expression, particularly eukaryotic expression, one will typically include a polyadenylation signal to effect proper polyadenylation of the transcript. The nature of the polyadenylation signal is not believed to be crucial to the successful practice of the invention, and any such sequence may be employed. Preferred embodiments include the SV40 polyadenylation signal or the bovine growth hormone polyadenylation signal, both of which are convenient, readily available, and known to function well in various target cells. Polyadenylation may increase the stability of the transcript or may facilitate cytoplasmic transport.

In order to propagate a vector in a host cell, it may contain one or more origins of replication sites (often termed “ori”), sites, which are specific nucleotide sequences at which replication is initiated. Alternatively, an autonomously replicating sequence (ARS) can be employed if the host cell is yeast.

Transformation Methodology

Suitable methods for nucleic acid delivery for use with the current invention are believed to include virtually any method by which a nucleic acid molecule (e.g., DNA) can be introduced into a cell as described herein or as would be known to one of ordinary skill in the art. Such methods include, but are not limited to, direct delivery of DNA such as by ex vivo transfection (Wilson, et al., Science, 244:1344-1346 (1989), Nabel et al, Science, 244:1342-1344 (1989), by injection (U.S. Pat. Nos. 5,994,624, 5,981,274, 5,945,100, 5,780,448, 5,736,524, 5,702,932, 5,656,610, 5,589,466 and 5,580,859, each incorporated herein by reference), including microinjection (Harlan and Weintraub, J. Cell Biol., 101(3):1094-1099 (1985); U.S. Pat. No. 5,789,215, incorporated herein by reference); by electroporation (U.S. Pat. No. 5,384,253, incorporated herein by reference; Tur-Kaspa, et al., Mol. Cell. Biol., 6:716-718 (1986); Potter, et al., Proc. Natl. Acad. Sci. USA, 81:7161-7165 (1984); by calcium phosphate precipitation (Graham and Van Der Eb, Virology, 52:456-467 (1973); Chen and Okayama, Mol. Cell. Biol., 7(8):2745-2752 (1987); Rippe, et al., Mol. Cell. Biol., 10:689-695 (1990); by using DEAE-dextran followed by polyethylene glycol (Gopal, Mol. Cell. Biol., 5:1188-190 (1985); by direct sonic loading (Fechheimer, et al., Proc. Natl. Acad. Sci. USA, 89(17):8463-8467 (1987); by liposome mediated transfection (Nicolau and Sene, Biochem. & Biophys. Acta., 721:185-190 (1982); Fraley, et al., Proc. Natl. Acad. Sci. USA, 76:3348-3352 (1979); Nicolau, et al., Meth. Enzym., 149:157-176 (1987); Wong, et al., Gene, 10:879-894 (1980); Kaneda, et al., Science, 243:375-378 (1989); Kato, et al., J. Biol. Chem., 266:3361-3364 (1991) and receptor-mediated transfection (Wu and Wu, J. Biol. Chem., 262:4429-4432 (1987); Wu and Wu, 1988); by PEG-mediated transformation of protoplasts (Omirulleh, et al., Plant Mol. Biol., 21(3):415-428 (1987); U.S. Pat. Nos. 4,684,611 and 4,952,500, each incorporated herein by reference); by desiccation/inhibition-mediated DNA uptake (Potrykus, et al Mol. Gen. Genet., 199(2):169-177 (1985), and any combination of such methods.

### II. COMPONENTS OF THE ASSAY SYSTEM

As with the method described herein, the products which are features of the invention have preferred embodiments. For example, in the “three part construct,” i.e., that contain sequences encoding a test protein, the cleavage site, and the activator protein, the test protein is preferably a membrane bound protein, such as a transmembrane receptor, e.g., a member of the GPCR family. These sequences can be modified so that the C terminus of the proteins they encode have better and stronger interactions with the second protein. The modifications can include, e.g., replacing a C-terminal encoding sequence of the test protein, such as a GPCR, with the C terminal coding region for AVPR2, AGTRLI, GRPR, F2PLI, CCR4, CXCR2/IL-8, CCR4, or GRPR, all of which are defined supra.

The protein which activates the reporter gene may be a protein which acts within the nucleus, like a transcription factor (e.g., tTA, GAL4, etc.), or it may be a molecule that sets a cascade of reactions in motion, leading to an intranuclear reaction by another protein. The skilled artisan will be well versed in such cascades.

The second construct, as described supra, includes a region which encodes a protein that interacts with the first protein, leading to some measurable phenomenon. The protein may be an activator, an inhibitor, or, more, generically, a “modulator” of the first protein. Members of the arrestin family are preferred, especially when the first protein is a GPCR, but other protein encoding sequences may be used, especially when the first protein is not a GPCR. The second part of these two part constructs encodes the protease, or portion of a protease, which acts to remove the activating molecule from the fusion protein encoded by the first construct.

However, these preferred embodiments do not limit the invention, as discussed in the following additional embodiments.

Host Cells

As used herein, the terms “cell,” “cell line,” and “cell culture” may be used interchangeably. All of these terms also include their progeny, which is any and all subsequent generations. It is understood that all progeny may not be identical due to deliberate or inadvertent mutations. The host cells generally will have been engineered to express a screenable or selectable marker which is activated by the transcription factor that is part of a fusion protein, along with the first test protein.

In the context of expressing a heterologous nucleic acid sequence, “host cell” refers to a prokaryotic or eukaryotic cell that is capable of replicating a vector and/or expressing a heterologous gene encoded by a vector. When host cells are “transfected” or “transformed” with nucleic acid molecules, they are referred to as “engineered” or “recombinant” cells or host cells, e.g., a cell into which an exogenous nucleic acid sequence, such as, for example, a vector, has been introduced. Therefore, recombinant cells are distinguishable from naturally-occurring cells which do not contain a recombinantly introduced nucleic acid.

Numerous cell lines and cultures are available for use as a host cell, and they can be obtained through the American Type Culture Collection (ATCC), which is an organization that serves as an archive for living cultures and genetic materials (www.atcc.org). An appropriate host can be determined by one of skill in the art based on the vector backbone and the desired result. A plasmid or cosmid, for example, can be introduced into a prokaryote host cell for replication of many vectors. Cell types available for vector replication and/or expression include, but are not limited to, bacteria, such as E. coli (e.g., E. coli strain RR1, E. coli LE392, E. coli B, E. coli X 1776 (ATCC No. 31537) as well as E. coli W3110 (F-, lambda-, prototrophic, ATCC No. 273325), DH5α, JM109, and KC8, bacilli such as Bacillus subtilis; and other enterobacteriaceae such as Salmonella typhimurium, Serratia marcescens, various Pseudomonas specie, as well as a number of commercially available bacterial hosts such as SURE® Competent Cells and SOLOPACK™ Gold Cells (STRATAGENE®, La Jolla). In certain embodiments, bacterial cells such as E. coli LE392 are particularly contemplated as host cells for phage viruses.

Examples of eukaryotic host cells for replication and/or expression of a vector include, but are not limited to, HeLa, NIH3T3, Jurkat, 293, COS, CHO, Saos, and PC12. Many host cells from various cell types and organisms are available and would be known to one of skill in the art. Similarly, a viral vector may be used in conjunction with either a eukaryotic or prokaryotic host cell, particularly one that is permissive for replication or expression of the vector.

Test Proteins

The present invention contemplates the use of any two proteins for which a physical interaction is known or suspected. The proteins will exist as fusions proteins, a first test protein fused to a transcription factor, and the second test protein fused to a protease that recognizes a cleavage site in the first fusion protein, cleavage of which releases the transcription factor. The only requirements for the test proteins/fusions are (a) that the first test protein cannot localize to the nucleus prior to cleavage, and (b) that the protease must remain active following both fusion to the second test protein and binding of the first test protein to the second test protein.

With respect to the first construct, the first test protein may be, e.g., a naturally membrane bound protein, or one which has been engineered to become membrane bound, via standard techniques. The first test protein may be, e.g., a transmembrane receptor such as any of the GPCRs, or any other transmembrane receptor of interest, including, but not being limited to, receptor tyrosine kinases, receptor serine threonine kinases, cytokine receptors, and so forth. Further, as it is well known that portions of proteins, will function in the same manner as the full length first test protein, such active portions of a first test protein are encompassed by the definition of protein herein.

As will be evident to the skilled artisan, the present invention may be used to assay for interaction with any protein, and is not limited in its scope to assaying membrane bound receptor, like the GPCRs. For example, the activity of other classes of transmembrane receptors, including but not limited to: receptor tyrosine kinases (RTKs), such as IGF1R, such as the epidermal growth factor receptor (EGFR), ErbB2/HER2/Neu or related RTKs; receptor serine/threonine kinases, such as Transforming Growth Factor-beta (TGFβ), activin, or Bone Morphogenetic Protein (BMP) receptors; cytokine receptors, such as receptors for the interferon family for interleukin, erythropoietin, G-CSF, GM-CSF, tumor necrosis factor (TNF) and leptin receptors; and other receptors, which are not necessarily normally membrane bound, such as estrogen receptor 1 (ESR1), and estrogen receptor 2 (ESR2). In each case, the method involves transfecting a cell with a modified receptor construct that directs the expression of a chimeric protein containing the receptor of interest, to which is appended, a protease cleavage site followed by a nucleic acid molecule encoding a transcription factor. The cell is co-transfected with a second construct that directs the expression of a chimeric protein consisting of an interacting protein fused, to the protease that recognizes and cleaves the site described supra. In the case of RTKs, such as the EGFR, this interacting protein may consist of a SH2 (Src homology domain 2) containing protein or portion thereof, such as phospholipase C (PLC) or Src homology 2 domain containing transforming protein 1 (SHC1). In the case of receptor serine/threonine kinases, such as TGFβ, activin, BMP receptors, this interacting protein may be a Smad protein or portion thereof. In the case of cytokine receptors, such as interferon-α/β or interferon-γ gamma receptors, this interacting protein may be a signal transducer and activator of transcription (STAT) protein such as, but not being limited to, Stat1, Stat2; Janus kinase (JAK) proteins Jak1, Jak2, or Tyk2; or portions thereof. In each case, the transfected cell contains a reporter gene that is regulated by the transcription factor fused to the receptor. An assay is then performed in which the transfected cells are treated with a test compound for a specific period and the reporter gene activity is measured at the end of the test period. If the test compound activates the receptor of interest, interactions between the receptor of interest and the interacting protein are stimulated, leading to cleavage of the protease site and release of the fused transcription factor, which is in turn measurable as an increase in reporter gene activity.

Other possible test protein pairs include antibody-ligands, enzyme-substrates, dimerizing proteins, components of signal transduction cascades, and other protein pairs well known to the art.

Reporters

The protein which activates a reporter gene may be any protein having an impact on a gene, expression or lack thereof which leads to a detectable signal. Typical protein reporters include enzymes such as chloramphenicol acetyl transferase (CAT), β-glucuronidase (GUS) or β-galactosidase. Also contemplated are fluorescent and chemiluminescent proteins such as green fluorescent protein, red fluorescent protein, cyan fluorescent protein luciferase, beta lactamase, and alkaline phosphatase.

Transcriptions Factors and Repressors

In accordance with the present invention, transcription factors are used to activate expression of a reporter gene in an engineered host cell. Transcription factors are typically classified according to the structure of their DNA-binding domain, which are generally (a) zinc fingers, (b) helix-turn-helix, (c) leucine zipper, (d) helix-loop-helix, or (e) high mobility groups. The activator domains of transcription factors interact with the components of the transcriptional apparatus (RNA polymerase) and with other regulatory proteins, thereby affecting the efficiency of DNA binding.

The Rel/Nuclear Factor kB (NF-kB) and Activating Protein-1 (AP-1) are among the most studied transcription factor families. They have been identified as important components of signal transduction pathways leading to pathological outcomes such as inflammation and tumorogenesis. Other transcription factor families include the heat shock/E2F family, POU family and the ATF family. Particular transcription factors, such as tTA and GAL4, are contemplated for use in accordance with the present invention.

Though transcription factors are one class of molecules that can be used, the assays may be modified to accept the use of transcriptional repressor molecules, where the measurable signal is downregulation of a signal generator, or even cell death.

Proteases and Cleavage Sites

Proteases are well characterized enzymes that cleave other proteins at a particular site. One family, the Ser/Thr proteases, cleave at serine and threonine residues. Other proteases include cysteine or thiol proteases, aspartic proteases, metalloproteinases, aminopeptidases, di & tripeptidases, carboxypeptidases, and peptidyl peptidases. The choice of these is left to the skilled artisan and certainly need not be limited to the molecules described herein. It is well known that enzymes have catalytic domains and these can be used in place of full length proteases. Such are encompassed by the invention as well. A specific embodiment is the tobacco etch virus nuclear inclusion A protease, or an active portion thereof. Other specific cleavage sites for proteases may also be used, as will be clear to the skilled artisan.

Modification of Test Proteins

The first test protein may be modified to enhance its binding to the interacting protein in this assay. For example, it is known that certain GPCRs bind arrestins more stably or with greater affinity upon ligand stimulation and this enhanced interaction is mediated by discrete domains, e.g., clusters of serine and threonine residues in the C-terminal tail (Oakley, et al., J. Biol. Chem., 274:32248-32257, 1999 and Oakley, et al., J. Biol. Chem., 276:19452-19460, 2001). Using this as an example, it is clear that the receptor encoding sequence itself may be modified, so as to increase the affinity of the membrane bound protein, such as the receptor, with the protein to which it binds. Exemplary of such modifications are modifications of the C-terminal region of the membrane bound protein, e.g., receptor, such as those described supra, which involve replacing a portion of it with a corresponding region of another receptor, which has higher affinity for the binding protein, but does not impact the receptor function. Examples 16 and 20, supra, show embodiments of this feature of the invention.

In addition, the second test protein may be modified to enhance its interaction with the first test protein. For example, the assay may incorporate point mutants, truncations or other variants of the second test protein, e.g., arrestin that are known to bind agonist-occupied GPCRs more stably or in a phosphorylation-independent manner (Kovoor, et al., J. Biol. Chem., 274:6831-6834, 1999).

### III. ASSAY FORMATS

As discussed above, the present invention, in one embodiment, offers a straightforward way to assess the interaction of two test proteins when expressed in the same cell. A first construct, as described supra, comprises a sequence encoding a first protein, concatenated to a sequence encoding a cleavage site for a protease or protease portion, which is itself concatenated to a sequence encoding a reporter gene activator. By “concatenated” is meant that the sequences described are fused to produce a single, intact open reading frame, which may be translated into a single polypeptide which contains all the elements. These may, but need not be, separated by additional nucleotide sequences which may or may not encode additional proteins or peptides. A second construct inserted into the recombinant cells is also as described supra, i.e., it contains both a sequence encoding a second protein, and the protease or protease portion. Together, these elements constitute the basic assay format when combined with a candidate agent whose effect on target protein interaction is sought.

However, the invention may also be used to assay more than one membrane bound protein, such as a receptor, simultaneously by employing different reporter genes, each of which is stimulated by the activation of a protein, such as the classes of proteins described herein. For example, this may be accomplished by mixing cells transfected with different receptor constructs and different reporter genes, or by fusing different transcription factors to each test receptor, and measuring the activity of each reporter gene upon treatment with the test compound. For example, it may be desirable to determine if a molecule of interest activates a first receptor and also determine if side effects should be expected as a result of interaction with a second receptor. In such a case one may, e.g., involve a first cell line encoding a first receptor and a first reporter, such as lacZ, and a second cell line encoding a second receptor and a second reporter, such as GFP. Preferred embodiments of such a system are seen in Examples 17 and 18. One would mix the two cell lines, add the compound of interest, and look for a positive effect on one, with no effect on the other.

It is contemplated that the invention relates both to assays where a single pair of interacting test proteins is examined, but more preferably, what will be referred to herein as “multiplex” assays are used. Such assays may be carried out in various ways, but in all cases, more than one pair of test proteins is tested simultaneously. This may be accomplished, e.g., by providing more than one sample of cells, each of which has been transformed or transfected, to test each interacting pair of proteins. The different transformed cells may be combined, and tested simultaneously, in one receptacle, or each different type of transformant may be placed in a different well, and then tested.

The cells used for the multiplex assays described herein may be, but need not be, the same. Similarly, the reporter system used may, but need not be, the same in each sample. After the sample or samples are placed in receptacles, such as wells of a microarray, one or more compounds may be screened against the plurality of interacting protein pairs set out in the receptacles.

The fusion proteins expressed by the constructs are also a feature of the invention. Other aspects of the invention which will be clear to the artisan, are antibodies which can identify the fusion proteins as well as various protein based assays for determining the presence of the protein, as well as hybridization assays, such as assays based on PCR, which determine expression of the gene.

### IV. KITS

Any of the compositions described herein may be comprised in a kit. The kits will thus comprise, in suitable container means for the vectors or cells of the present invention, and any additional agents that can be used in accordance with the present invention.

The kits may comprise a suitably aliquoted compositions of the present invention. The components of the kits may be packaged either in aqueous media or in lyophilized form. The container means of the kits will generally include at least one vial, test tube, flask, bottle, syringe or other container means, into which a component may be placed, and preferably, suitably aliquoted. Where there are more than one component in the kit, the kit also will generally contain a second, third or other additional container into which the additional components may be separately placed. However, various combinations of components may be comprised in a vial. The kits of the present invention also will typically include a means for containing reagent containers in close confinement for commercial sale. Such containers may include injection or blow-molded plastic containers into which the desired vials are retained.

When the components of the kit are provided in one and/or more liquid solutions, the liquid solution is an aqueous solution, with a sterile aqueous solution being particularly preferred. However, the components of the kit may be provided as dried powder(s). When reagents and/or components are provided as a dry powder, the powder can be reconstituted by the addition of a suitable solvent. It is envisioned that the solvent may also be provided in another container means.

### V. EXAMPLES

Specific embodiments describing the invention will be seen in the examples which follow, but the invention should not be deemed as limited thereto.

### Example 1

A fusion construct was created, using DNA encoding human P2 adrenergic receptor, referred to hereafter as “ADRB2”, in accordance with standard nomenclature. Its nucleotide sequence can be found at GenBank, under Accession Number NM_{—}000024 (SEQ ID NO: 1). The tetracycline controlled transactivator tTA, described by Gossen, et al., Proc. Natl. Acad. Sci. USA, 87:5547-5551 (1992), incorporated by reference, was also used. A sequence encoding the recognition and cleavage site for tobacco etch virus nuclear inclusion A protease, described by Parks, et al., Anal. Biochem., 216:413-417 (1994), incorporated by reference, is inserted between these sequences in the fusion coding gene. The CMV promoter region was placed upstream of the ADRB2 coding region, and a poly A sequence was placed downstream of the tTA region.

A fusion construct was prepared by first generating a form of ADRB2 which lacked internal BamHI and BglII restriction sites. Further, the endogenous stop codon was replaced with a unique BamHI site.

Overlapping PCR was used to do this. To elaborate, a 5′ portion of the coding region was amplified with:

| | |
|---|---|
| gattgaagat ctgccttctt gctggc, | (SEQ ID NO: 2) |
| and | |
| gcagaacttg gaagacctgc ggagtcc, | (SEQ ID NO: 3) |

while a 3′ portion of the coding region was amplified with:

| | |
|---|---|
| ggactccgca ggtcttccaa gttctgc, | (SEQ ID NO: 4) |
| and | |
| ttcggatcct agcagtgagt catttgt. | (SEQ ID NO: 5) |

The resulting PCR products have 27 nucleotides of overlapping sequence and were purified via standard agarose gel electrophoresis. These were mixed together, and amplified with SEQ ID NO: 2, and SEQ ID NO: 5.

PCR was also used to modify the coding region of tTA so that the endogenous start codon was replaced with a TEV NIa-Pro cleavage site. The cleavage site, defined by the seven amino acid sequence ENLYFQS (SEQ ID NO: 6), is taught by Parks, et al., Anal. Biochem., 216:413-417 (1994), incorporated by reference. The seventh amino acid is known as P1′ position, and replacing it with other amino acids is known to reduce the efficiency of cleavage by TEV NIa-Pro. See Kapust, et al., Biochem. Biophys. Res. Commun., 294:949-955 (2002).

Variants where the seventh amino acid was changed to Tyr, and where it was changed to Leu, were produced. These resulted in intermediate and low efficiency cleavage sites, as compared to the natural high efficiency site.

A DNA sequence encoding the natural high efficiency site was added to the tTA coding region in two steps. Briefly, BamHI and XbaI restriction sites were added to the 5′ end and a XhoI restriction site was added to the 3′ end of the tTA coding region by PCR with

(SEQ ID NO: 7)

ccggatcctc tagattagat aaaagtaaag tg
and

(SEQ ID NO: 8)

gactcgagct agcagtatcc tcgcgccccc taccc,

and the TEV NIa-Pro cleavage site was added to the 5′ end by ligating an oligonucleotide with the sequence

| | |
|---|---|
| gagaacctgt acttccag | (SEQ ID NO: 9) |

between the BamHI and XbaI sites.

This DNA sequence was modified to encode the intermediate and low efficiency cleavage sites by PCR using:

(SEQ ID NO: 13)

ggatccgaga acctgtactt ccagctaaga tta,
and

(SEQ ID NO: 11)

ctcgagagat cctcgcgccc cctacccacc
for ENLYFQL (SEQ ID NO: 14).

These PCR steps also introduced a BamHI restriction site 5′ to the sequence encoding each cleavage site, and an XhoI restriction site 3′ to tTA stop codon.

The thus modified ADRB2 coding region was digested with PstI, which cuts at nucleotide position 260 in the coding region, and BamHI. This 3′ fragment was ligated with the three variants of tTA modified with the TEV NIa-Pro cleavage sites, that had been digested with BamHI and XhoI, and the resulting complexes were cloned into pBlueScript II, which had been digested with PstI and XhoI.

A NotI restriction site was introduced 5′ to the start codon of the ADRB2 coding region, again via PCR, using

(SEQ ID NO: 15)

gcggccgcca ccatgaacgg taccgaaggc cca,
and

(SEQ ID NO: 16)

ctggtgggtg gcccggtacc a.

The 5′ fragment of modified ADRB2 coding region was isolated, via digestion with NotI and PstI and was ligated into each of the constructs of the 3′ fragment of ADRB2-TEV-NIa-Pro-cleavage site tTA fusions that had been digested previously, to produce three, full length constructs encoding fusion proteins.

Each construct was digested with NotI and XhoI, and was then inserted into the commercially available expression vector pcDNA 3, digested with NotI and XhoI.

### Example 2

A second construct was also made, whereby the coding sequence for “β arrestin 2 or ARRB2” hereafter (GenBank, NM_{—}004313) (SEQ ID NO: 17), was ligated to the catalytic domain of the TEV NIa protease (i.e., amino acids 189-424 of mature NIa protease, residues 2040-2279) in the TEV protein. To do this, a DNA sequence encoding ARRB2 was modified, so as to add a BamHI restriction site to its 5′ end. Further, the sequence was modified to replace the endogenous stop codon with a BamHI site. The oligonucleotides

(SEQ ID NO: 18)

caggatcctc tggaatgggg gagaaacccg ggacc,
and

(SEQ ID NO: 19)

catagtcgtc

were used. The resulting PCR product was cloned into the commercially available vector pGEM-T EASY (Promega). The multiple cloning site of the pGEM-T EASY vector includes an EcoRI site 5′ to the start codon of ARRB2.

The TEV NIa-Pro coding region was then modified to replace the endogenous start codon with a BglII site, and to insert at the 3′ end a sequence which encodes influenza hemagluttinin epitope YPYDVPDYA (SEQ ID NO: 20) in accordance with Kolodziej, et al., Meth. Enzymol., 194:508-519 (1991), followed by a stop codon, and a NotI restriction site. This was accomplished via PCR, using

(SEQ ID NO: 21)

agatctagct tgtttaaggg accacgtg,
and

(SEQ ID NO: 22)

gcggccgctc aagcgtaatc tggaacatca tatgggtacg
agtacaccaa ttcattcatg ag.

The resulting, modified ARRB2 coding region was digested with EcoRI and BamHI, while the modified TEV coding region was cleaved with BglII and NotI. Both fragments were ligated into a commercially available pcDNA3 expression vector, digested with EcoRI and NotI.

### Example 3

Plasmids encoding ADRB2-TEV-NIa-Pro cleavage site-tTA and the ARRB2-TEV-NIa protease fusion proteins were transfected into HEK-293T cells, and into “clone 41,” which is a derivative of HEK-293T, that has a stably integrated β-galactosidase gene under control of a tTA dependent promoter. About 5×10⁴ cells were plated in each well of a 24 well plate, in DMEM medium supplemented with 10% fetal bovine serum, 2 mM L-glutamine, 100 units/ml penicillin, 100 μg/ml G418, and 5 μg/ml purimycin. Cells were grown to reach 50% confluency the next day, and were then transfected, using 0.4 μg plasmid DNA, and 2 μl Fugene (a proprietary transfection reagent containing lipids and other material). The mix was combined in 100 μl of DMEM medium, and incubated for 15 minutes at room temperature prior to adding cells. Transfected cells were incubated for 8-20 hours before testing by adding drugs which are known agonists for the receptor, and then 16-24 hours after drug addition.

### Example 4

The levels of β-galactosidase activity in the cells were first measured by staining the cells with a chromogenic substance, i.e., “X-gal,” as taught by MacGregor, et al., Somat. Cell Mol. Genet., 13:253-265 (1987), incorporated by reference. Following culture, cells were washed, twice, in D-PBS with calcium and magnesium, fixed for 5 minutes in 4% paraformaldehyde, and then washed two additional times with D-PBS, calcium and magnesium, for 10 minutes each time. Fixed cells were incubated with 5 mM potassium ferricyanide, 5 mM potassium ferrocyanide, 2 mM MgCl₂, 0.1% X-Gal, that had been prepared from a 1:40 dilution of 4% X-Gal stock in dimethylformamide, in D-PBS with calcium and magnesium.

The reaction was incubated in the dark at room temperature for from 3-4 hours, to overnight. Substrate solution was removed, and cells were mounted under glass coverslips with mowiol mounting medium (10% mowiol, 0.1% 1.4-diazabicyclo[2.2.2]octane, 24% glycerol).

The results indicated that cells transfected with either the ADRB2-TEV-NIa-Pro cleavage site-tTA plasmid alone or the ARRB2-TEV-NIa protease plasmid alone did not express β-galactosidase. A small fraction of cells transfected with both plasmids did express β-galactosidase, probably due to basal levels of interaction between unstimulated ADRB2 and ARRB2. About 3-5 fold more cells expressed the reporter gene after treatment with either 10 μM isoproterenol, or 10 μM epinephrine, both of which are ADRB2 agonists.

When the cells were pretreated for 5 minutes with the ADRB2 antagonist alprenolol (10 μM), the agonist induced increase in β-galactosidase expressing cells was blocked, and treatment with alprenolol alone had no apparent effect.

These results show that one can link agonist binding and GPCR stimulation to transcriptional activation of a reporter gene.

### Example 5

A set of experiments were carried out in order to quantify the level of reporter gene activity in the cells more precisely and to maximize the signal-to-background ratio of the assay. This was accomplished by measuring the level of reporter gene induction using a commercially available chemiluminescence assay for β-galactosidase activity. Clone 41 cells were transfected with the ADRB2-tTA fusion constructs, containing either the high, medium or low efficiency cleavage sites, and the ARRB2-TEV-NIa protease expression plasmid described supra. Cells were either untreated or treated with 1 μM isoproterenol 20 hours after the transfection, and the luminescence assay was carried out 24 hours after the drug addition. In brief, following cell culture, the medium was removed, and 50 μl of lysis buffer (100 mM potassium phosphate, pH7.8, 0.2% Triton X-100) was added to each well. The cells were lysed via incubation for 5 minutes, at room temperature, with mild agitation. Lysates were collected and analyzed via commercially available products.

In all cases, treatment with agonist increased levels of β-galactosidase activity. However, the background level of reporter gene activity in untreated cells was lowest with the low efficiency cleavage site, relative to the medium and high efficiency sites. Further, agonist treatment resulted in a 4.8-fold stimulation of reporter gene activity in cells transfected with the low efficiency cleavage site, compared to 2.8-fold for the medium efficiency cleavage site and 1.2-fold for the high efficiency cleavage site. Thus, the highest signal-to-background ratio is obtained by using the low efficiency protease cleavage site.

### Example 6

These experiments were designed to verify that the agonist stimulated increase in reporter gene expression is dependent on binding and activation of the receptor by the agonist.

To do this, variants of the ADRB2-tTA fusion constructs were generated following the protocols supra, except each contained a mutant form of the receptor with a single amino acid change from D to S at position 113, which results in a greatly reduced affinity for the agonist isoproterenol. See Strader, et al., J. Biol. Chem., 266:5-8 (1991). Three forms of the mutant receptor-tTA fusion construct with each of the different cleavage sites were formed.

The levels of β-galactosidase activity were measured in clone 41 cells co-transfected with the ADRB2-tTA fusion constructs containing the D113S point mutation and the ARRB2-TEV-NIa protease expression plasmid described previously. The activity tests were carried out exactly as described, supra. The results indicated that the agonist isoproterenol did not stimulate reporter gene expression in cells expressing the mutant ADRB2-tTA fusion contructs.

### Example 7

These experiments were designed to examine whether the agonist stimulated increase in reporter gene expression is dependent on fusion of TEV NIa-Pro to ARRB2.

To do this, the levels of β-galactosidase activity were measured in clone 41 cells co-transfected with the ADRB2-tTA fusion construct containing the low efficiency cleavage site and either the ARRB2-TEV-NIa protease expression plasmid described supra, or a control TEV-NIa protease fusion to the SH2 domain of phospholipase C. The activity tests were carried out exactly as described, supra. The results indicated that agonist-stimulated increase in reporter gene expression was detected only when the TEV protease was fused to ARRB2 and not when fused to an unrelated polypeptide.

### Example 8

These experiments were designed to determine if gene expression is induced selectively by agonists of the target receptor, or if it can be stimulated by other molecules.

ATP is an agonist for G protein coupled receptors P2Y1 and P2Y2, which are expressed endogenously by HEK-293T cells.

Experiments were carried out using clone 41 cells which were cotransfected with the ADRB2-tTA fusion construct containing the low efficiency cleavage site and the arrestin-TEV-NIa protease fusion as described supra, which were treated with isoproterenol, ATP, or untreated. The assays were carried out as described, supra.

The results indicated that induction of reporter gene activity was specific to activation of target receptor. Stimulation of another GPCR pathway was irrelevant.

### Example 9

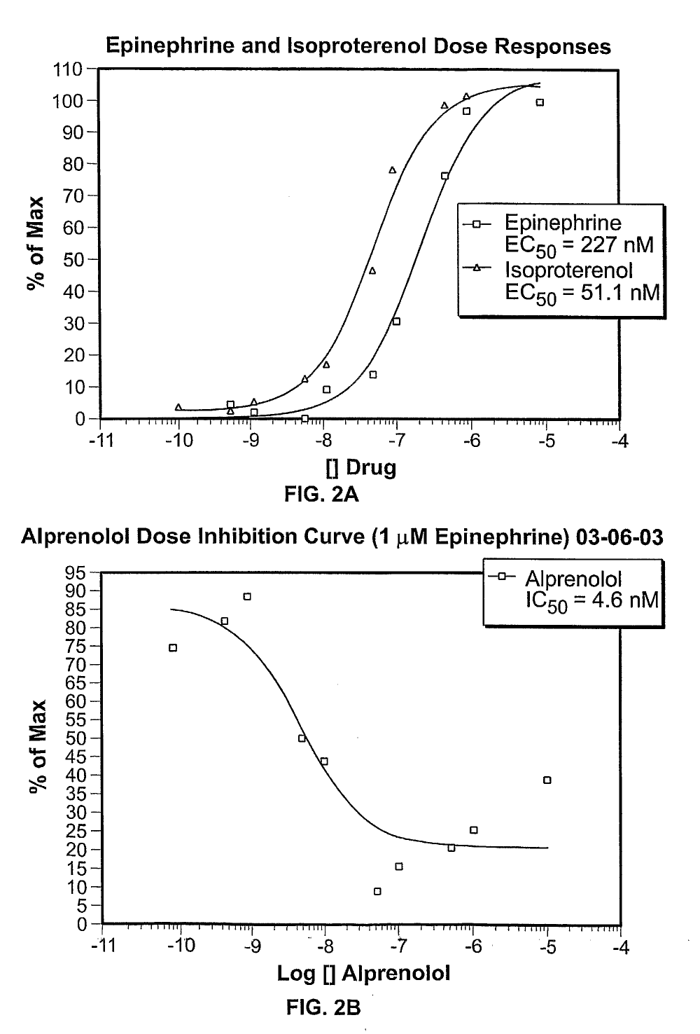

A set of experiments were carried out using clone 41 cells which were cotransfected with the ADRB2-tTA fusion construct containing the low efficiency cleavage site and the ARRB2-TEV-NIa protease fusion as described supra, which were treated with varying amounts of one of the adrenergic receptor agonists isoproterenol and epinephrine. The assays were carried out as described, supra. The results presented in FIG. 2a show a dose-response curve for the stimulation of reporter gene expression by these two ligands. Each point represents the mean value obtained from three experiments.

A set of experiments were carried out as described supra, in which the co-transfected clone 41 cells were pretreated with varying concentrations of the adrenergic receptor antagonist alprenolol for 15 minutes, followed by treatment with 1 μM epinephrine. The results shown in FIG. 2b indicate a dose-inhibition curve for this antagonist.

### Example 10

A similar set of constructs were made to establish an assay for the G protein coupled arginine vasopressin receptor 2 (AVPR2). The AVPR2 coding region (Genbank Accession Number: NM_{—}000054) (SEQ ID NO: 23) was modified to place an EcoRI site at the 5′ end and replace the stop codon with a BamHI site using PCR with the primers

| | |
|---|---|
| gaattcatgc tcatggcgtc caccac | (SEQ ID NO: 24) |
| and | |
| ggatcccgat gaagtgtcct tggccag. | (SEQ ID NO: 25) |

The modified AVPR2 coding region was ligated into the three ADRB2-tTA constructs described supra, which had been cut with EcoRI and BamHI. This replaced the entire coding sequence of the ADRB2 with the coding sequence of AVPR2.

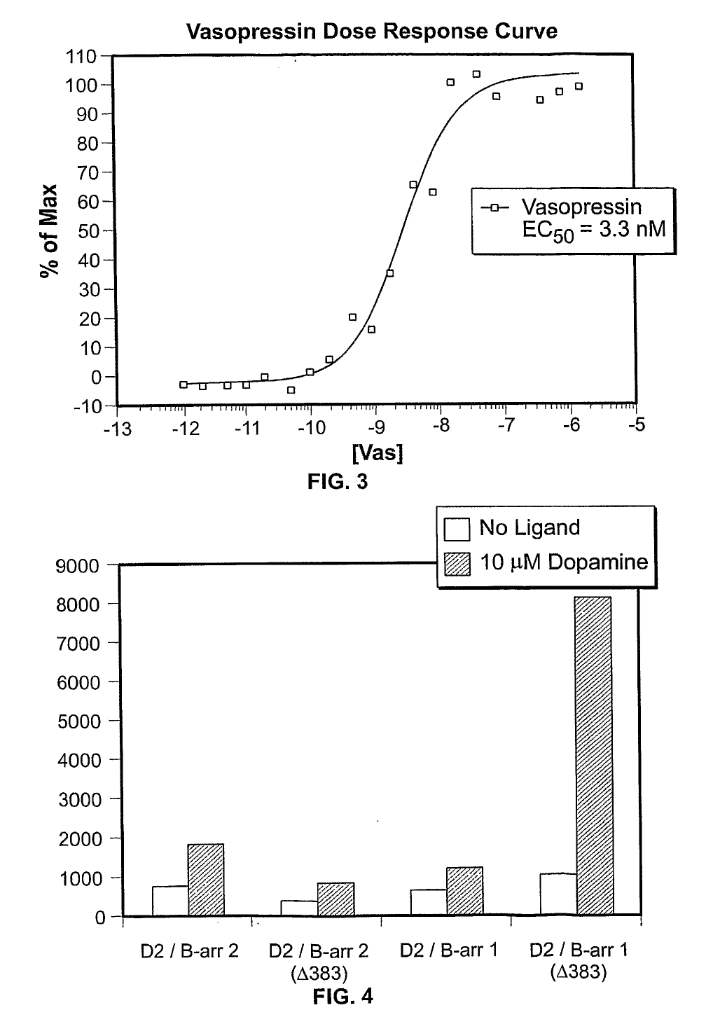

Clone 41 cells were co-transfected with the AVPR2-tTA fusion construct containing the low efficiency cleavage site and the ARRB2-TEV-NIa protease fusion described supra, and assays were carried out using varying concentrations (1 pM to 2 μM) of [Arg8] vasopressin, an agonist for AVPR2. The data, presented in FIG. 3, shows a dose-response curve for this agonist, with an EC50 of 3.3 nM, which agrees with previously published data (Oakley, R., et. al., Assay and Drug Development Technologies, 1:21-30, (2002)). The maximal response resulted in an approximately 40-fold induction of reporter gene expression over the background level.

### Example 11

A similar set of constructs were made to establish an assay for the G protein coupled serotonin receptor 1a (HTR1A). The HTR1A coding region (Genbank Accession Number: NM_{—}000524) (SEQ ID NO: 26) was modified to place an EcoRI site at the 5′ end and replace the stop codon with a BamHI site using PCR with the primers

| | |
|---|---|
| gaattcatgg atgtgctcag ccctgg | (SEQ ID NO: 27) |
| and | |
| ggatccctgg cggcagaact tacac. | (SEQ ID NO: 28) |

The modified HTR1A coding region was ligated into the AVPR2-tTA constructs described supra, which had been cut with EcoRI and BamHI. This replaced the entire coding sequence of AVPR2 with the coding sequence of HTR1A. The resulting construct will be referred to as “HTR1A-tTA” hereafter.

Clone 41 cells were co-transfected with the HTR1A-tTA fusion construct containing the low efficiency cleavage site and the ARRB2-TEV-NIa protease fusion construct described supra, and assays were carried out using 10 μM 8-hydroxy-DPAT HBr (OH-DPAT), an agonist for the HTR1A, as well as with 10 μM serotonin, a natural agonist for HTR1A. The assays were carried out as described, supra. The maximal response to OH-DPAT resulted in a 6.3-fold induction of reporter gene expression over background level and the maximal response to serotonin resulted in a 4.6-fold induction of reporter gene expression over background level.

### Example 12

Similar constructs were made to establish an assay for the G protein coupled m2 muscarinic acetylcholine receptor (CHRM2). The CHRM2 coding region (Genbank Accession Number: NM_{—}000739) (SEQ ID NO: 29) was modified to place an EcoRI site at the 5′ end and replace the stop codon with a BglII site using PCR with the primers

| | |
|---|---|
| gaattcatga ataactcaac aaactcc | (SEQ ID NO: 30) |
| and | |
| agatctcctt gtagcgccta tgttc. | (SEQ ID NO: 31) |

The modified CHRM2 coding region was ligated into the AVPR2-tTA constructs described supra, which had been cut with EcoRI and BamHI. This replaced the entire coding sequence of AVPR2 with the coding sequence of CHRM2.

Clone 41 cells were co-transfected with the CHRM2-tTA fusion construct containing the high efficiency cleavage site and the ARRB2-TEV-NIa protease fusion described supra, where the ARRB2-protease fusion protein was expressed under the control of the Herpes Simplex Virus thymidine kinase (HSV-TK) promoter, and assays were carried out using 10 μM carbamylcholine Cl (carbochol), an agonist for CHRM2, as described supra. The maximal response to carbochol resulted in a 7.2-fold induction of reporter gene expression over background.

### Example 13

α Constructs were also made to establish an assay for the G protein coupled chemokine (C—C motif) receptor 5 (CCR5). The CCR5 coding region (Genbank Accession Number: NM_{—}000579) (SEQ ID NO: 32) was modified to place Not I site at the 5′ end and replace the stop codon with a BamHI site using PCR with the primers

| | |
|---|---|
| gcggccgcat ggattatcaa gtgtcaagtc c | (SEQ ID NO: 33) |
| and | |
| ggatccctgg cggcagaact tacac. | (SEQ ID NO: 34) |

The CCR5 coding region was also modified to place a BsaI site at the 5′ end which, when cut, leaves a nucleotide overhang which is compatible with EcoRI cut DNA using the primers

(SEQ ID NO: 35)

ggtctccaat tcatggatta tcaagtgtca agt
and

(SEQ ID NO: 36)

gacgacagcc aggtacctat c.

The first modified coding region was cut with ClaI and BamHI and the second was cut with BsaI and ClaI. Both fragments were ligated into the AVPR2-tTA constructs described supra, which had been cut with EcoRI and BamHI. This replaced the entire coding sequence of AVPR2 with the coding sequence of CCR5.

The CCR5-tTA fusion construct containing the low efficiency cleavage site was transfected into “clone 34” cells, which are a derivative of the HEK cell line “clone 41” described supra, but which contain a stably integrated ARRB2-TEV-NIa protease fusion gene under the control of the CMV promoter. Assays were carried out using 1 μg/ml “Regulated on Activation, Normal T-Cell Expressed and Secreted” (RANTES), a known agonist for CCR5. The maximal response to RANTES, measured as described supra resulted in an approximately 40-fold induction of reporter gene expression over the background.

### Example 14

Next, a set of constructs were made to establish an assay for the G protein coupled dopamine 2 receptor (DRD2). The DRD2 coding region (Genbank Accession Number: NM_{—}000795) (SEQ ID NO: 37) was modified to place an EcoRI site at the 5′ end and replace the stop codon with a BglII site using PCR with the primers

| | |
|---|---|
| gaattcatgg atccactgaa tctgtcc | (SEQ ID NO: 38) |
| and | |
| agatctgcag tggaggatct tcagg. | (SEQ ID NO: 39) |

The modified DRD2 coding region was ligated into the AVPR2-tTA constructs described supra, cut with EcoRI and BamHI. This replaced the entire coding sequence of AVPR2 with the coding sequence of DRD2.

Clone 41 cells were co-transfected with the DRD2-tTA fusion construct containing the medium efficiency cleavage site and the ARRB2-TEV-NIa protease fusion described supra, and assays were carried out using 10 μM dopamine HCl (dopamine), an agonist for DRD2. Results were measured as in the assays described supra. The maximal response to dopamine resulted in a 2.7-fold induction of reporter gene expression over the background.

### Example 15

These experiments were designed to demonstrate enhancements of the assay using arrestin variants that bind agonist-occupied GPCRs more stably. First, a fusion of the TEV NIa protease to β-arrestin-1 (ARRB1) was constructed. The coding region of ARRB1 (Genbank Accession Number: NM_{—}004041) (SEQ ID NO: 40) was modified to place an Asp718 site at the 5′ end and replace the stop codon with a BamHI site using PCR with the primers

(SEQ ID NO: 41)

ggtaccatgg gcgacaaagg gacgcgagtg
and

(SEQ ID NO: 42)

ggatcctctg ttgttgagct gtggagagcc tgtaccatcc
tcctcttc.

The resulting modified ARRB1 coding region was cut with Asp718 and EcoRI and with EcoRI and BamHI, while the modified TEV NIa-Pro coding region described supra was cut with BglII and NotI. All three fragments were ligated into a commercially available pcDNA3 expression vector, which had digested with Asp718 and NotI.

Clone 41 cells were co-transfected with the DRD2-tTA fusion construct containing the medium efficiency cleavage site and the ARRB1-TEV-NIa protease fusion, and assays were carried out using 10 μM dopamine HCl (dopamine), an agonist for the D2 receptor, as described supra. The maximal response to dopamine resulted in a 2.1-fold induction of reporter gene expression over the background.

Truncation of ARRB1 following amino acid 382 has been reported to result in enhanced affinity for agonist-bound GPCRs, independent of GRK-mediated phosphorylation (Kovoor A., et. al., J. Biol. Chem., 274(11):6831-6834 (1999)). To demonstrate the use of such a “constitutively active” arrestin in the present assay, the coding region of β-arrestin-1 was modified to place an Asp718 site at the 5′ end and a BamHI site after amino acid 382 using PCR with SEQ ID NO: 41, supra and

| | |
|---|---|
| ggatccattt gtgtcaagtt ctatgag. | (SEQ ID NO: 43) |

This results in a an ARRb1 coding region which is 36 amino acids shorter than the full-length coding region. The resulting modified ARRB1 coding region, termed “ARRB1 (Δ383)”, was cut with Asp718 and EcoRI and with EcoRI and BamHI, while the modified TEV NIa-Pro coding region described supra was cut with BglII and NotI. All three fragments were ligated into a commercially available pcDNA3 expression vector, digested with Asp718 and NotI.

Clone 41 cells were co-transfected with the DRD2-tTA fusion construct containing the medium efficiency cleavage site and the ARRB1 (Δ383)-TEV-NIa protease fusion, and assays were carried out using 10 μM dopamine HCl (dopamine), an agonist for the DRD2 receptor, as described supra. The maximal response to dopamine resulted in an 8.3-fold induction of reporter gene expression over the background.

To examine the effect of a comparable truncation of the ARRB2 coding region the coding region of ARRB2 was modified to place an Asp718 site at the 5′ end and replaced 81 nucleotides at the 3′ end with a BamHI site using PCR with the primers

| | |
|---|---|
| ggtaccatgg gggagaaacc cgggacc | (SEQ ID NO: 44) |
| and | |
| ggatcctgtg gcatagttgg tatc. | (SEQ ID NO: 45) |

This results in a ARRB2 coding region which is 27 amino acids shorter than the full-length coding region. The resulting modified ARRB2 coding region was cut with. Asp718 and BamHI, while the modified TEV NIa-Pro coding region described supra was cut with BglII and NotI. Both fragments were ligated into a commercially available pcDNA3 expression vector, digested with Asp718 and NotI.

Clone 41 cells were co-transfected with the DRD2-tTA fusion construct containing the medium efficiency cleavage site and the ARRB2 (Δ383)-TEV-NIa protease fusion, and assays were carried out using 10 μM dopamine HCl (dopamine), an agonist for the DRD2 receptor, as described supra. The maximal response to dopamine resulted in a 2.1-fold induction of reporter gene expression over the background.

These results, presented in FIG. 4, demonstrate that DRD2 dopamine receptor assay shows the highest signal-to-background ratio using the arrestin variant ARRB1 (Δ383).

### Example 16

This set of experiments was carried out to demonstrate enhancements of the assay using receptor modifications that are designed to increase affinity for the interacting protein. In this example, the C-terminal tail domain of a test receptor was replaced with the corresponding tail domain from AVPR2, a receptor known to bind arrestins with high affinity. In these examples the fusion junction was made 15-18 amino acids after the conserved NPXXY motif at the end of the seventh transmembrane helix, which typically corresponds to a position immediately after a putative palmitoylation site in the receptor C-terminus.

First, PCR was used to produce a DNA fragment encoding the C-terminal 29 amino acids from AVPR2, followed by the low efficiency TEV cleavage site and tTA transcription factor. The fragment was also designed such that the first two amino acids (Ala, A and Arg, R) are encoded by the BssHII restriction site GCGCGC. This was accomplished by amplifying the AVPR2-tTA construct with the low efficiency cleavage site described supra, with the primers

(SEQ ID NO: 46)

tgtgcgcgcg gacgcacccc acccagcctg ggt

(SEQ ID NO: 11)

ctcgagagat cctcgcgccc cctacccacc.

Next, the coding region of the DRD2 was modified to place an EcoRI site at the 5′ end and to insert a BssHII site after the last amino acid in the coding region (Cys-443). This was done using PCR with the primers

(SEQ ID NO: 47)

gaattcatgg atccactgaa tctgtcc
and

(SEQ ID NO: 48)

tgtgcgcgcg cagtggagga tcttcaggaa ggc.

The resulting modified D2 coding region was cut with EcoRI and BssHII and the resulting AVPR2 C-terminal tail-low efficiency cleavage site-tTA fragment was cut with BssHII and BamHI. Both fragments were ligated into the AVPR2-low efficiency cleavage site-tTA construct described supra, cut with EcoRI and BamHI.

Clone 41 cells were co-transfected with the DRD2-AVPR2 Tail-tTA fusion construct containing the low efficiency TEV cleavage site and the ARRB2-TEV-NIa protease fusion described supra, and assays were carried out using 10 μM dopamine HCl (dopamine), an agonist for the DRD2 receptor. The maximal response to dopamine resulted in an approximately 60-fold induction of reporter gene expression over the background.

A construct was made which modified the ADRB2 receptor coding region by inserting an Asp718 site at the 5′ end and by placing a BssHII site after Cys-341. This was done using PCR with the primers

(SEQ ID NO: 49)

gcggccgcca ccatgaacgg taccgaaggc cca
and

(SEQ ID NO: 50)

tgtgcgcgcg cacagaagct cctggaaggc.

The modified ADRB2 receptor coding region was cut with EcoRI and BssHII and the AVPR2 C-terminal tail-low efficiency cleavage site-tTA fragment was cut with BssHII and BamHI. Both fragments were ligated into the AVPR2-low efficiency cleavage site-tTA construct described supra cut, with EcoRI and BamHI. The resulting construct is “ADRB2-AVPR2 Tail-tTA.” (Also see published application U.S. 2002/0106379, supra, SEQ ID NO: 3 in particular.)

Clone 41 cells were co-transfected with the ADRB2-AVPR2 Tail-tTA fusion construct containing the low efficiency TEV cleavage site and the ARRB2-TEV-NIa protease fusion described supra, and such assays were carried out using 10 μM isoproterenol, an agonist for the ADRB2 receptor. The maximal response to isoproterenol resulted in an approximately 10-fold induction of reporter gene expression over the background.

A construct was made which modified the kappa opioid receptor (OPRK; Genbank Accession Number: NM_{—}000912) (SEQ ID NO: 51) coding region by placing a BssHII site after Cys-345. This was done using PCR with the primers

| | |
|---|---|
| ggtctacttg atgaattcct ggcc | (SEQ ID NO: 52) |
| and | |
| gcgcgcacag aagtcccgga aacaccg | (SEQ ID NO: 53) |

The modified OPRK receptor coding region was cut with EcoRI and BssHII and AVPR2 C-terminal tail-low efficiency cleavage site-tTA fragment was cut with BssHII and XhoI. Both fragments were ligated into a plasmid containing the modified OPRK receptor sequence, cloned into pcDNA3.1+ at Asp718 (5′) and XhoI (3′), which had been digested with EcoRI and XhoI.

Clone 41 cells were co-transfected with the OPRK-AVPR2 Tail-tTA fusion construct containing the low efficiency cleavage site and the ARRB2-TEV-NIa protease fusion described supra, and assays were carried out using 10 μM U-69593, an agonist for the OPRK. The maximal response to U-69593 resulted in an approximately 12-fold induction of reporter gene expression over the background.

### Example 17

This experiment was designed to demonstrate the use of the assay to measure the activity of two test receptors simultaneously using a multiplex format.

Clone 41 cells and “clone 1H10” cells, which are cells of an HEK-293T cell line containing a stable integration of the luciferase gene under the control of a tTA-dependent promoter, were each plated on 24-well culture dishes and were transiently transfected with the chimeric ADRB2-AVPR2 Tail-tTA or the DRD2-AVPR2 Tail-tTA fusion constructs described supra, respectively. Transient transfections were performed using 100 μl of media, 0.4 μg of DNA and 2 μl of FuGene reagent per well. After 24 hr of incubation, Clone 41 cells expressing ADRB2-AVPR2 Tail-tTA and clone 1H10 cells expressing DRD2-AVPR2 Tail-tTA were trypsinized, mixed in equal amounts, and replated in 12 wells of a 96-well plate. Triplicate wells were incubated without drug addition or were immediately treated with 1 μM isoproterenol, 1 μM dopamine, or a mixture of both agonists at 1 μM. Cells were assayed for reporter gene activity approximately 24 hours after ligand addition. Medium was discarded, cells were lysed in 40 μl lysis buffer [100 mM potassium phosphate pH 7.8, 0.2% Triton X-100] and the cell lysate was assayed for beta-galactosidase and for luciferase activity using commercially available luminescent detection reagents.

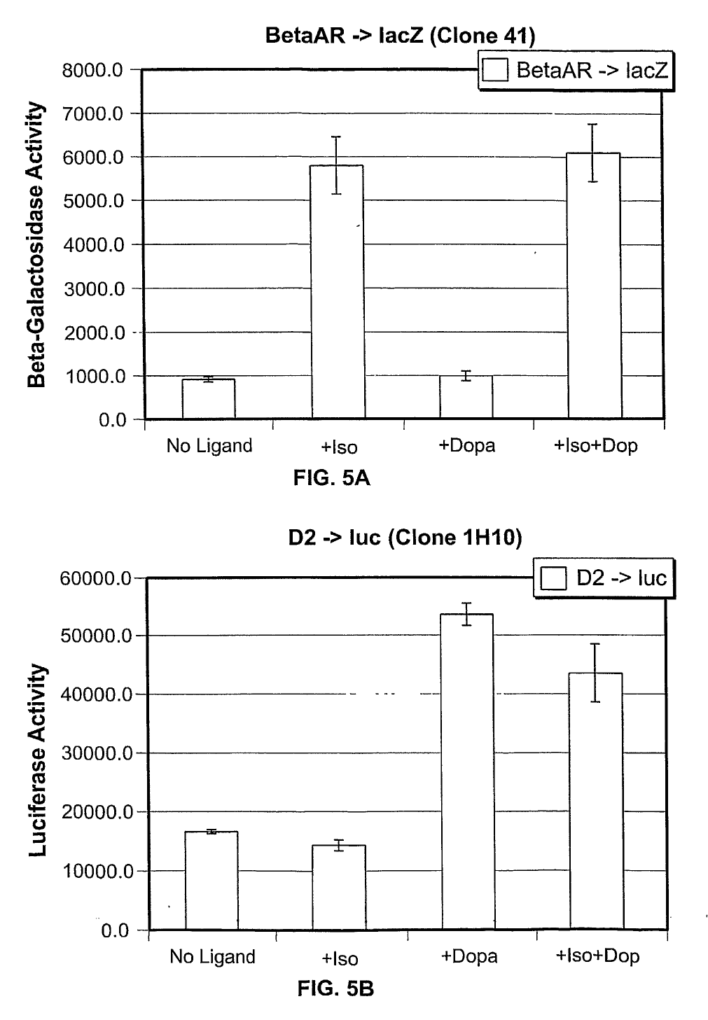

The results are presented in FIGS. 5A and 5B. Treatment with isoproterenol resulted in an approximately seven-fold induction of beta-galactosidase reporter gene activity, whereas luciferase activity remained unchanged. Treatment with dopamine resulted in a 3.5-fold induction of luciferase activity, while beta-galactosidase activity remained unchanged. Treatment with both isoproterenol and dopamine resulted in seven-fold and three-fold induction of beta-galactosidase and luciferase activity, respectively.

### Example 18

This experiment was designed to demonstrate the use of the assay to measure the activity of two test receptors simultaneously using a multiplex format.

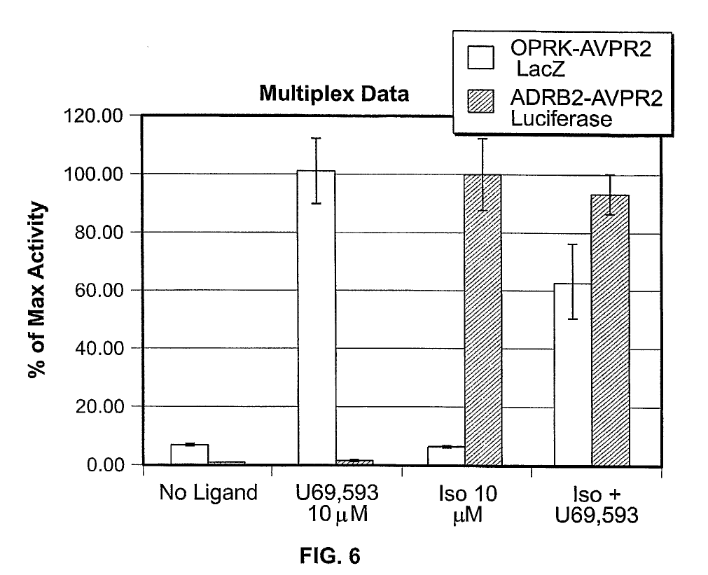

“Clone 34.9” cells, which are a derivative of clone 41 cells and containing a stably integrated ARRB2-TEV NIa protease fusion protein gene, were transiently transfected with the chimeric OPRK-AVPR2 Tail-TEV-NIa-Pro cleavage (Leu)-tTA fusion construct described supra. In parallel, “clone HTL 5B8.1” cells, which are an HEK-293T cell line containing a stable integrated luciferase gene under the control of a tTA-dependent promoter, were transiently transfected with the ADRB-AVPR2 Tail-TEV-NIa-Pro cleavage (Leu)-tTA fusion construct described supra. In each case 5×10⁵ cells were plated in each well of a 6-well dish, and cultured for 24 hours in DMEM supplemented with 10% fetal bovine serum, 2 mM L-Glutamine, 100 units/ml penicillin, 500 μg/ml G418, and 3 μg/ml puromycin. Cells were transiently transfected with 100 μl of DMEM, 0.5 μg of OPRK-AVPR2 Tail-TEV-NIa-Pro cleavage (Leu)-tTA DNA, and 2.5 μl Fugene (“clone 34.9 cells”) or with 100 μl of DMEM, 0.5 μg of ADRB2-AVPR2 Tail-TEV-NIa-Pro cleavage (Leu)-tTA DNA, 0.5 μg of ARRB2-TEV NIa Protease DNA and 5 μl Fugene (“clone HTL 5B8.1 cells”). Transiently transfected cells were cultured for about 24 hours, and were then trypsinized, mixed in equal amounts and replated in wells of a 96 well plate. Cell were incubated for 24 hours before treatment with 10 μM U-69593, 10 μM isoproterenol or a mixture of both agonists at 10 μM. Sixteen wells were assayed for each experimental condition. After 24 hours, cells were lysed and the activity of both beta-galactosidase and luciferase reporter genes were assayed as described supra. The results are presented in FIG. 6. Treatment with U-69593 resulted in an approximately 15-fold induction of beta-galactosidase reporter gene activity, whereas luciferase activity remained unchanged. Treatment with isoproterenol resulted in a 145-fold induction of luciferase activity, while beta-galactosidase activity remained unchanged. Treatment with both U-69593 and isoproterenol resulted in nine-fold and 136-fold induction of beta-galactosidase and luciferase activity, respectively.

### Example 19

This experiment was carried out to demonstrate the use of a different transcription factor and promoter in the assay of the invention.

A fusion construct was created, comprising DNA encoding AVPR2, fused in frame to a DNA sequence encoding the amino acid linker GSENLYFQLR (SEQ ID NO: 54) which included the low efficiency cleavage site for TEV NIa-Pro described supra, fused in frame to a DNA sequence encoding amino acids 2-147 of the yeast GAL4 protein (GenBank Accession Number P04386) (SEQ ID NO: 55) followed by a linker, i.e., of the sequence PELGSASAELTMVF (SEQ ID NO: 56), followed by amino acids 368-549 of the murine nuclear factor kappa-B chain p65 protein (GenBank Accession Number A37932) (SEQ ID NO: 57). The CMV promoter was placed upstream of the AVPR2 coding region and a polyA sequence was placed downstream of the GAL4-NFkB region. This construct was designated AVPR2-TEV-NIa-Pro cleavage (Leu)-GAL4.

HUL 5C1.1 is a derivative of HEK-293T cells, which contain a stably integrated luciferase reporter gene under the control of a GAL4 upstream activating sequence (UAS), commercially available pFR-LUC.

This AVPR2-TEV-NIa-Pro cleavage (Leu)-GAL4 plasmid was co-transfected along with the β-arrestin2-TEV NIa Protease described supra into HUL 5C1.1 cells. About 2.5×10⁴ cells were plated into each well of a 96 well-plate, in DMEM medium supplemented with 10% fetal bovine serum, 2 mM L-Glutamine, 100 units/ml penicillin, 500 μg/ml G418, and 3 μg/ml puromycin. Cells were grown to reach 50% confluency the next day and were transfected with 10 μl per well of a mixture consisting of 85 μl of DMEM, 0.1 μg of AVPR2-TEV-NIa-Pro cleavage (Leu)-GAL4 DNA, 0.1 μg of ARRB2-TEV NIa Protease DNA, and 1 μl Fugene, which had been incubated for 15 minutes at room temperature prior to addition to the cells. Transfected cells were cultured for about 16 hours before treatment with 10 μM vasopressin. After six hours, cells were lysed and luciferase activity was assayed as described supra. Under these conditions, treatment with vasopressin resulted in a 180-fold increase in reporter gene activity.

### Example 20

This set of experiments were carried out to demonstrate enhancements of the assay using further receptor modifications that are designed to increase the affinity for the interacting protein. In this example, the C-terminal tail domain of the test receptor is replaced with the corresponding tail domain of one of the following receptors: apelin J receptor—AGTRL1 (accession number: NM_{—}005161) (SEQ ID NO: 58), gastrin-releasing peptide receptor—GRPR (accession number: NM_{—}005314) (SEQ ID NO: 59), proteinase-activated receptor 2—F2RL1 (accession number: NM_{—}005242) (SEQ ID NO: 60), CCR4 (accession number: NM_{—}005508) (SEQ ID NO: 61), chemokine (C—X—C motif) receptor 4—CXCR4 (accession number: NM_{—}003467) (SEQ ID NO: 62), and interleukin 8 receptor, beta—CXCR2/IL8b (accession number: NM_{—}001557) (SEQ ID NO: 63).

First PCR was used to produce a DNA fragment encoding the C-terminal tail of the above receptors. These fragments were designed such that the first two amino acids (Ala, A and Arg, R) are encoded by the BssHII restriction site.

The AGTRL1 C-terminal fragment was amplified with the primers

| | |
|---|---|
| tgtgcgcgcg gccagagcag gtgcgca. | (SEQ ID NO: 64) |
| and | |
| gaggatccgt caaccacaag ggtctc. | (SEQ ID NO: 65) |

The GRPR C-terminal fragment was amplified with the primers

| | |
|---|---|
| tgtgcgcgcg gcctgatcat ccggtct | (SEQ ID NO: 66) |
| and | |
| gaggatccga cataccgctc gtgaca. | (SEQ ID NO: 67) |

The F2RL1 C-terminal fragment was amplified with the primers

| | |
|---|---|
| tgtgcgcgca gtgtccgcac tgtaaagc | (SEQ ID NO: 68) |
| and | |
| gaggatccat aggaggtctt aacagt. | (SEQ ID NO: 69) |

The CCR4 C-terminal fragment was amplified with the primers

| | |
|---|---|
| tgtgcgcgcg gcctttttgt gctctgc | (SEQ ID NO: 70) |
| and | |
| gaggatccca gagcatcatg aagatc. | (SEQ ID NO: 71) |

The CXCR2/IL8b C-terminal fragment was amplified with the primers

| | |
|---|---|
| tgtgcgcgcg gcttgatcag caagggac | (SEQ ID NO: 72) |
| and | |
| gaggatccga gagtagtgga agtgtg. | (SEQ ID NO: 73) |

The CXCR4 C-terminal fragment was amplified with the primers

| | |
|---|---|
| tgtgcgcgcg ggtccagcct caagatc | (SEQ ID NO: 74) |
| and | |
| gaggatccgc tggagtgaaa acttga. | (SEQ ID NO: 75) |

The resulting DNA fragments encoding the modified C-terminal tail domains of these receptors were cut with BssHII and BamHI and the fragments were ligated in frame to the OPRK receptor coding region, replacing the AVPR2-C-terminal tail fragment, in the OPRK-AVPR2 Tail-TEV-NIa-Pro cleavage (Leu)-tTA expression construct described supra.

HTL 5B8.1 cells described supra were co-transfected with each of the above modified OPRK coding region TEV-NIa-Pro cleavage (Leu)-tTA constructs and the β-arrestin 2-TEV NIa protease fusion described supra. About 2.5×10⁴ cells per well were plated onto a 96 well-plate, in DMEM medium supplemented with 10% fetal bovine serum, 2 mM L-Glutamine, 100 units/ml penicillin, 500 μg/ml G418, and 3 μg/ml puromycin. Cells were grown to reach 50% confluency the next day and were transfected with 10 μl per well of a mixture consisting of 85 μl of DMEM, 0.25 μg of AVPR2-TEV-NIa-Pro cleavage (Leu)-GAL4 DNA, 0.25 μg of ARRB2-TEV NIa protease DNA, and 2.5 μl Fugene (a proprietary transfection reagent containing lipids and other material), which had been incubated for 15 minutes at room temperature prior to addition to the cells. Transfected cells were cultured for about 16 hours before treatment 10 μM U-69593. After six hours, cells were lysed and luciferase activity was assayed as described supra. Under these conditions, treatment with U-69593 resulted in the following relative increases in reporter gene activity for each of the modified OPRK receptors: OPRK-AGTRL1 C-terminal tail—30 fold; OPRK-GRPR C-terminal tail—312 fold; OPRK-F2RL1 C-terminal tail—69.5 fold; OPRK-CCR4 C-terminal tail—3.5 fold; OPRK-CXCR4 C-terminal tail—9.3 fold; OPRK-IL8b C-terminal tail—113 fold.

### Example 21

This experiment was designed to produce a cell line that stably expressed the ARRB2-TEV NIa protease fusion protein described supra.

A plasmid was made which expressed the ARRB2-TEV NIa protease fusion protein under the control of the EF1α promoter and also expressed the hygromycin resistance gene under the control of the thymidine kinase (TK) promoter.

This plasmid was transfected into HTL 5B8.1, and clones containing a stable genomic integration of the plasmid were selected by culturing in the presence of 100 μg/ml hygromycin. Resistant clones were isolated and expanded and were screened by transfection of the ADRB2-AVPR2 Tail-TEV-NIa-Pro cleavage (Leu)-tTA plasmid described supra. Three cell lines that were selected using this procedure were designated “HTLA 4C2.10”, “HTLA 2C11.6” and “HTLA 5D4”. About 2.5×10⁴ cells per well were plated onto a 96 well-plate, in DMEM medium supplemented with 10% fetal bovine serum, 2 mM L-Glutamine, 100 units/ml penicillin, 500 μg/ml G418, 3 μg/ml puromycin, and 100 μg/ml hygromycin. Cells were grown to reach 50% confluency the next day and were transfected with 10 μl per well of a mixture consisting of 85 μl of DMEM, 0.25 μg of ADRB2-AVPR2-TEV-NIa-Pro cleavage (Leu)-GAL4 DNA and 0.5 μl Fugene, which had been incubated for 15 minutes at room temperature prior to addition to the cells. Transfected cells were cultured for about 16 hours before treatment 10 μM isoproterenol. After six hours, cells were lysed and luciferase activity was assayed as described supra. Under these conditions, treatment with isoproterenol resulted in a 112-fold (“HTLA 4C2.10”), 56-fold (“HTLA 2C11.6”) and 180-fold (“HTLA 5D4”) increase in reporter gene activity in the three cell lines, respectively.

### Example 22

This experiment was designed to produce a cell line that stably expressed the ARRB2-TEV NIa protease and the ADRB2-AVPR2 Tail-TEV-NIa-Pro cleavage (Leu)-tTA fusion proteins described supra.

The ARRB2-TEV NIa protease plasmid containing the hygromycin resistance gene was transfected together with the ADRB2-AVPR2 Tail-TEV-NIa-Pro cleavage (Leu)-tTA fusion protein plasmid described supra into HTL 5B8.1 cells and clones containing stable genomic integration of the plasmids were selected by culturing in the presence of 100 μg/ml hygromycin. Resistant clones were isolated and expanded, and were screened by treating with 10 μM isoproterenol and measuring the induction of reporter gene activity as described supra. Three cell lines that were selected using this procedure were designated “HTLAR 1E4”, “HTLAR 1C10” and “HTLAR 2G2”. Treatment with isoproterenol for 6 hours resulted in a 208-fold (“HTLAR 1E4”), 197-fold (“HTLAR 1C10”) and 390-fold (“HTLAR 2G2”) increase in reporter gene activity in the three cell lines, respectively.

### Example 23

This experiment was designed to demonstrate the use of the assay to measure the activity of the receptor tyrosine kinase epidermal growth factor receptor (EGFR).

A first fusion construct was created, comprising DNA encoding the human EGFR, which can be found at GenBank under the Accession Number NM_{—}005228 (SEQ ID NO: 76), fused in frame to a DNA sequence encoding amino acids 3-335 of the tetracycline-controlled transactivator tTA, described supra. Inserted between these sequences is a DNA sequence encoding the amino acid sequence GGSGSENLYFQL (SEQ ID NO: 77) which includes the low efficiency cleavage site for TEV NIa-Pro, ENLYFQL (SEQ ID NO: 14), described supra. The CMV promoter was placed upstream of the Epidermal Growth Factor Receptor coding region, and a polyA sequence was placed downstream of the tTA region. This construct is designated EGFR-TEV-NIa-Pro cleavage (Leu)-tTA.

A second fusion construct was created, comprising DNA encoding the two SH2 domains of human Phospholipase C Gamma 1, corresponding to amino acids 538-759 (GeneBank accession number NP_{—}002651.2) (SEQ ID NO: 78) fused in frame to a DNA sequence encoding the catalytic domain of mature TEV NIa protease, described supra, corresponding to amino acids 2040-2279 (GeneBank accession number AAA47910) (SEQ ID NO: 79). Inserted between these sequences is a linker DNA sequence encoding the amino acids NSSGGNSGS (SEQ ID NO: 80). The CMV promoter was placed upstream of the PLC-Gamma SH2 domain coding sequence and a polyA sequence was placed downstream of the TEV NIa protease sequence. This construct is designated PLC Gamma1-TEV.

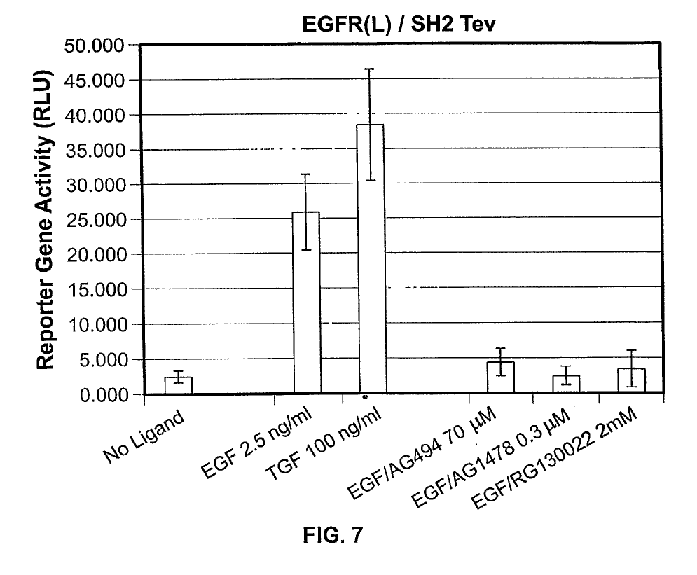

The EGFR-TEV-NIa-Pro cleavage (Leu)-tTA and PLC Gamma1-TEV fusion constructs were transfected into clone HTL5B8.1 cells described supra. About 2.5×10⁴ cells were plated into each well of a 96 well-plate, in DMEM medium supplemented with 10% fetal bovine serum, 2 mM L-Glutamine, 100 units/ml penicillin, 500 μg/ml G418, and 3 μg/ml puromycin. Cells were grown to reach 50% confluency the next day and were transfected with 15 μl per well of a mixture consisting of 100 μl of DMEM, 0.4 μg of pcDNA3 DNA (“carrier” vector DNA), 0.04 μg of EGFR-TEV-NIa-Pro cleavage (Leu)-tTA DNA, 0.04 μg of PLC Gamma1-TEV DNA, and 2 μl Fugene (a proprietary transfection reagent containing lipids and other material), which had been incubated for 15 minutes at room temperature prior to addition to the cells. Transfected cells were cultured for about 16 hours before treatment with specified receptor agonists and inhibitors. After six hours, cells were lysed and luciferase activity was assayed as described supra. Results are shown in FIG. 7.

The addition of 2.5 ng/ml human Epidermal Growth Factor (corresponding to the EC80 for this ligand) resulted in a 12.3 fold increase of luciferase reporter gene activity, while addition of 100 ng/ml human Transforming Growth Factor—Alpha resulted in an 18.3 fold increase. Prior treatment with tyrosine kinase inhibitors (70 μM AG-494; 0.3 μM AG-1478; 2 mM RG-130022) before addition of human Epidermal Growth Factor blocked the induction of reporter gene activity.

### Example 24

This experiment was designed to demonstrate the use of the assay to measure the activity of the human Type I Interferon Receptor.

A fusion construct was created, comprising DNA encoding Human Interferon Receptor I (IFNAR1) (557 amino acids), which can be found in Genbank under Accession Number NM_{—}000629 (SEQ ID NO: 81), fused in frame to a DNA sequence encoding amino acids 3-335 of the tetracycline controlled transactivator tTA, described supra. Inserted between these sequences is a DNA sequence encoding the amino acid sequence GSENLYFQL (SEQ ID NO: 82) which includes the low efficiency cleavage site for TEV NIa-Pro, ENLYFQL (SEQ ID NO: 14), described supra. The CMV promoter was placed upstream of the Human Interferon Receptor I (IFNAR1) coding region, and a poly A sequence was placed downstream of the tTA region. This construct is designated IFNAR1-TEV-NIa-Pro cleavage (L)-tTA.

A second fusion construct was created, using DNA encoding Human Interferon Receptor 2, splice variant 2 (IFNAR2.2) (515 amino acids), which can be found at Genbank, under Accession Number L41942 (SEQ ID NO: 83), fused in frame to a DNA sequence encoding the catalytic domain of the TEV NIa protease, described supra corresponding to amino acids 2040-2279 (GenBank accession number AAA47910) (SEQ ID NO: 84). Inserted between these sequences is a DNA sequence encoding the amino acid sequence RS (Arg-Ser). The CMV promoter region was placed upstream of the Human Interferon Receptor 2 (IFNAR2.2) coding region, and a poly A sequence was placed downstream of the TEV region. This construct is designated IFNAR2.2-TEV.

Expression constructs were also generated in which the genes for Human Signal Transducer and Activator of Transcription 1 (STAT1), found in Genbank, under Accession Number NM_{—}007315 (SEQ ID NO: 85), Human Signal Transducer and Activator of Transcription 2 (STAT2) found in Genbank, under Accession Number NM_{—}005419 (SEQ ID NO: 86), were expressed under the control of the CMV promoter region. These constructs were designated CMV-STAT1 and CMV-STAT2 respectively.

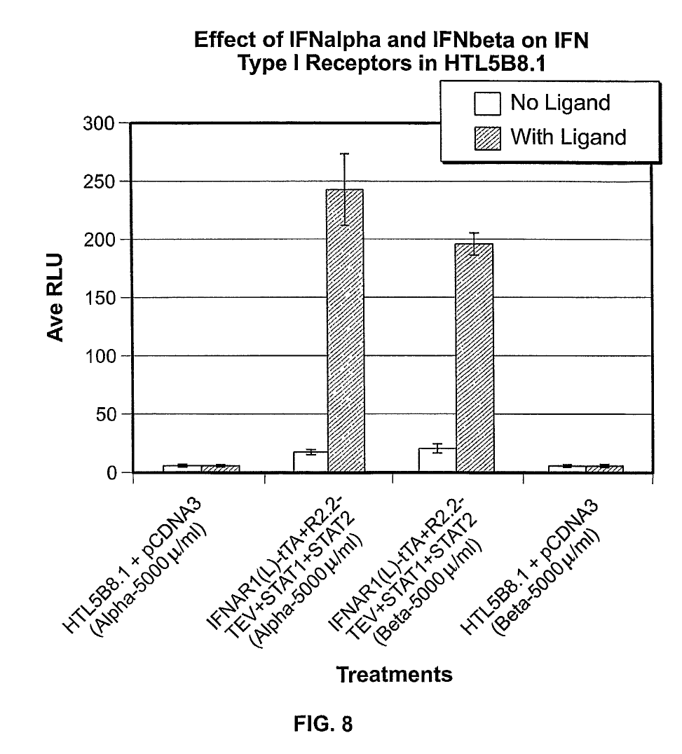

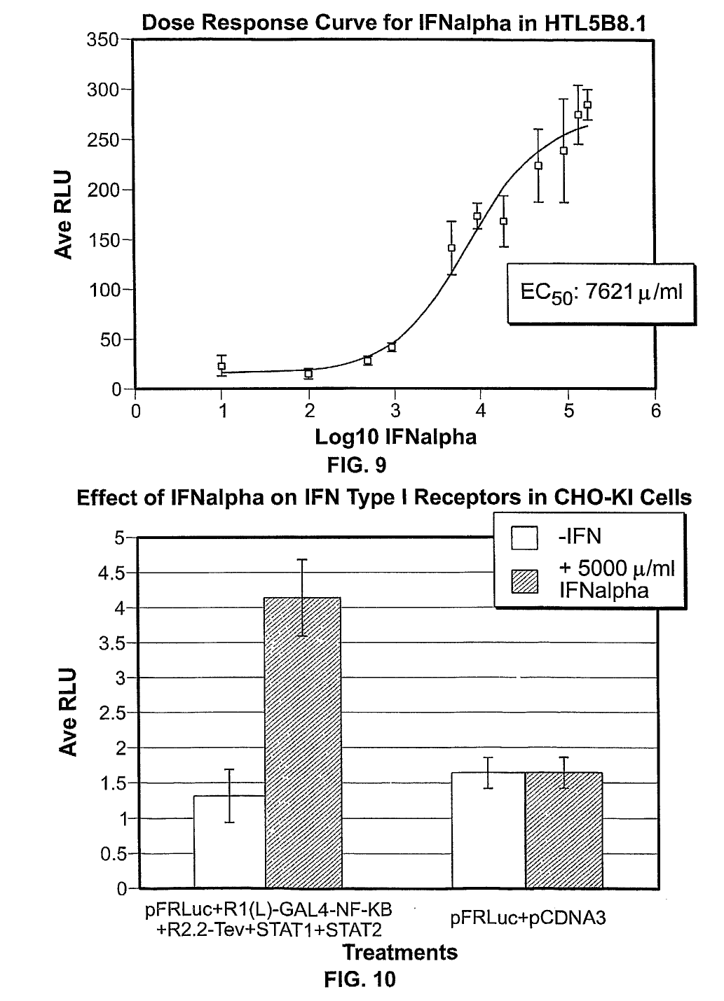

The IFNAR1-TEV-NIa-Pro cleavage (L)-tTA and IFNAR2.2-TEV fusion constructs, together with CMV-STAT1 and CMV-STAT2 were transiently transfected into HTL5B8.1 cells described supra. About 2.5×10⁴ cells were seeded in each well of a 96 well plate and cultured in DMEM medium supplemented with 10% fetal bovine serum, 2 mM L-glutamine, 100 units/ml penicillin, 100 μg/ml G418, and 5 μg/ml puromycin. After 24 hours of incubation, cells were transfected with 15 ng of each IFNAR1-TEV-NIa-Pro cleavage (L)-tTA, IFNAR2.2-TEV, CMV-STAT1 and CMV-STAT2 DNA, or with 60 ng control pcDNA plasmid, together with 0.3 μl Fugene per well. Transfected cells were cultured for 8-20 hours before treatment with 5000 U/ml human interferon-alpha or 5000 U/ml human interferon-beta. At the time of interferon addition, medium was aspirated and replaced with 293 SFM II media supplemented with 2 mM L-glutamine, 100 units/ml penicillin, 3 μg/ml puromycin and 500 μg/ml of G418. Interferon-treated cells were cultured for an additional 18-20 hours before they were assayed for luciferase reporter gene activity as described supra. Results are shown in FIG. 8. Treatment with 5000 U/ml IFN-α resulted in 15-fold increase in reporter gene activity, while treatment with 5000 U/ml IFN-β resulted in a 10-fold increase. Interferon treatment of HTL5B8.1 cells transfected with the control plasmid pcDNA3 had no effect on reporter gene activity. FIG. 9 shows a dose-response curve generated for IFN-α in HTL5B8.1 cells transfected with IFNAR1(ENLYFQ(L)-tTa, IFNAR2.2-TEV, STAT1 and STAT2 expression constructs as described supra.

### Example 25

This experiment was designed to demonstrate the use of the assay to measure the activity of the human Type I Interferon Receptor using a different transcription factor and a different cell line.

A fusion construct was created, using DNA encoding Human Interferon Receptor I (IFNAR1), fused in frame to a DNA sequence encoding the GAL4-NF-κB-fusion, described supra. Inserted between these sequences is a DNA sequence encoding the amino acid sequence GSENLYFQL (SEQ ID NO: 87), which includes the low efficiency cleavage site for TEV NIa-Pro, ENLYFQL (SEQ ID NO: 14), described supra. The CMV promoter was placed upstream of the Human Interferon Receptor I (IFNAR1) coding region, and a poly A sequence was placed downstream of the GAL4-NF-κB region. This construct is designated IFNAR1-TEV-NIa-Pro cleavage (L)-GAL4-NF-κB.

CHO-K1 cells were then transiently transfected with a mixture of five plasmids: IFNAR1-TEV-NIa-Pro cleavage (L)-GAL4-NF-KB, IFNAR2.2-TEV, CMV-STAT1, CMV-STAT2 and pFR-Luc, a luciferase reporter gene plasmid under the control of a GAL4-dependent promoter. About 1.0×10⁴ cells per well were seeded in a 96 well plate 24 hours prior to transfections in DMEM medium supplemented with 10% fetal bovine serum, 2 mM L-glutamine, 100 unites/ml penicillin. Cells were transfected the following day with 10 ng of reporter plasmid (pFR-Luc), plus 20 ng of each of the expression constructs described supra, or with 10 ng reporter plasmid plus 80 ng of control pcDNA3 plasmid, together with 0.3 μl Fugene per well. Transfected cells were cultured for 8-20 hours before treatment with 5000 U/ml human interferon-alpha. At the time of interferon addition, medium was aspirated and replaced with DMEM media supplemented with 2 mM L-glutamine, 100 units/ml penicillin. Interferon-treated cells were cultured for an additional 6 hours before they were assayed for luciferase reporter gene activity as described supra. Results are shown in FIG. 10. IFN-α treatment of CHO-K1 cells transfected with the reporter, IFNAR and STAT constructs resulted in 3-fold increase in reporter gene activity, while interferon treatment of cells transfected with the reporter and control plasmids had no effect on reporter gene activity.

### Example 26

This set of experiments was carried out to demonstrate additional enhancements of the assay using receptor modifications designed to increase the affinity of the test receptor for the interacting protein. In these examples, the fusion junction between the test receptor and a C-terminal tail domain of GRPR (Genbank Accession Number: NM_{—}005314) (SEQ ID NO: 59) was made 17-23 amino acids after the conserved NPXXY motif at the end of the seventh transmembrane helix.

First, PCR was used to produce a DNA fragment encoding the C-terminal 42 amino acids from GRPR beginning 2 amino acids after the putative palmitoylation site (hereafter referred to as GRPR 42aa). The fragment was designed such that the first amino acid of the C-terminal tail is preceded by two amino acids (Ser, S and Arg, R) which are encoded by the XbaI restriction site TCTAGA, and the stop codon is replaced by two amino acids (Gly, G and Ser, S) which are encoded by a BamHI restriction site GGATCC. This was accomplished by amplifying a plasmid containing the GRPR coding region with primers

| | |
|---|---|
| tctagaggcctgatcatccggtctcac | (SEQ ID NO: 88) |
| and | |
| gaggatccgacataccgctcgtgaca | (SEQ ID NO: 67) |

Next the coding region of OPRK (Genbank Accession Number: NM_{—}000912) (SEQ ID NO: 51) was modified to place insert an XbaI site after Pro-347. This was done using PCR with the primers

| | |
|---|---|
| ggtctacttgatgaattcctggcc | (SEQ ID NO: 52) |
| and | |
| tctagatggaaaacagaagtcccggaaac | (SEQ ID NO: 89) |

In addition, the coding region of ADRA1A (Genbank Accession Number: NM_{—}000680) (SEQ ID NO: 90) was modified to insert an XbaI site after Lys-349. This was done using PCR with the primers

| | |
|---|---|
| ctcggatatctaaacagctgcatcaa | (SEQ ID NO: 91) |
| and | |
| tctagactttctgcagagacactggattc | (SEQ ID NO: 92) |

In addition, the coding region of DRD2 (Genbank Accession Number: NM_{—}000795) (SEQ ID NO: 37) was modified to insert two amino acids (Leu and Arg) and an XbaI site after Cys-343. This was done using PCR with the primers

| | |
|---|---|
| gaattcatggatccactgaatctgtcc | (SEQ ID NO: 38) |
| and | |
| tctagatcgaaggcagtggaggatcttcagg | (SEQ ID NO: 93) |

The modified OPRK receptor coding region was cut with EcoRI and XbaI and the GRPR 42aa C-terminal tail fragment was cut with XbaI and BamHI. Both fragments were ligated into a plasmid containing the OPRK receptor with the AVPR2 C-terminal tail-low-efficiency cleavage site-tTA described supra which had been digested with EcoRI and BamHI.

The modified ADRA1A receptor coding region was cut with EcoRV and XbaI and the OPRK-GRPR 42aa Tail-tTA fusion construct containing the low efficiency cleavage site was cut with XbaI and XhoI. Both fragments were ligated into a plasmid containing the ADRA1A receptor which had been digested with EcoRV and XhoI.

The modified DRD2 receptor coding region was cut with EcoRI and XbaI and the OPRK-GRPR 42aa Tail-tTA fusion construct containing the low efficiency cleavage site was cut with XbaI and XhoI. Both fragments were ligated into a pcDNA6 plasmid digested with EcoRI and XhoI

HTLA 2C11.6 cells, described supra, were transfected with OPRK-GRPR 42aa Tail-tTA fusion construct containing the low efficiency cleavage site and assays were carried out using 10 μM U-69593, an agonist for OPRK. The maximal response to U-69593 resulted in an approximately 200-fold increase in reporter gene activity.

HTLA 2C11.6 cells were transfected with ADRA1A-GRPR 42aa Tail-tTA fusion construct containing the low efficiency cleavage site and assays were carried out using 10 μM epinephrine, an agonist for ADRA1A. The maximal response to epinephrine resulted in an approximately 14-fold increase in reporter gene activity.

HTLA 2C11.6 cells were transfected with DRD2-GRPR 42aa Tail-tTA fusion construct containing the low efficiency cleavage site and assays were carried out using μM dopamine, an agonist for DRD2. The maximal response to dopamine resulted in an approximately 30-fold increase in reporter gene activity.

### Example 27

This set of experiments were carried out to demonstrate further enhancements of the assay using a different set of test receptor modifications designed to increase the affinity for the interacting protein. In these examples, the C-terminal domain of the test receptor was replaced with a portion of the endogenous C-terminal tail domain of GRPR.

First, PCR was used to produce a DNA fragment encoding the truncated GRPR tail, specifically a sequence encoding 23 amino acids from Gly-343 to Asn-365. The fragment was designed such that the first amino acid of the C-terminal tail is preceded by two amino acids (Ser, S and Arg, R) which are encoded by the XbaI restriction site TCTAGA, and the Ser-366 is replaced by two amino acids (Gly, G and Ser, S) which are encoded by a BamHI restriction site GGATCC. This was accomplished by amplifying a plasmid containing the GRPR coding region with primers

| | |
|---|---|
| tctagaggcctgatcatccggtctcac | (SEQ ID NO: 94) |
| and | |
| cggatccgttggtactcttgagg | (SEQ ID NO: 95) |

Next the truncated GRPR fragment (hereafter referred to as GRPR 23 aa Tail) was cut with XbaI and BamHI and inserted into the OPRK-GRPR 42aa Tail-tTA fusion construct containing the low efficiency cleavage site described herein, digested with XbaI and BamHI.

Similarly, the GRPR 23aa Tail fragment was cut with XbaI and BamHI and inserted into the ADRA1A-GRPR 42aa Tail-tTA fusion construct containing the low efficiency cleavage site described herein, digested with XbaI and BamHI.

HTLA 2C11.6 cells were transfected with OPRK-GRPR 23aa Tail -tTA fusion construct containing the low efficiency cleavage site and assays were carried out using 10 μM U-69593, an agonist for OPRK. The maximal response to U-69593 resulted in an approximately 115-fold induction of reporter gene expression over the background.

HTLA 2C11.6 cells were transfected with ADRA1A-GRPR 23aa Tail-tTA fusion construct containing the low efficiency cleavage site and assays were carried out using 10 μM epinephrine, an agonist for ADRA1A. The maximal response to epinephrine resulted in an approximately 102-fold induction of reporter gene expression over the background.

### Example 28

This experiment was designed to demonstrate the use of the assay to measure the activity of the receptor tyrosine kinase Insulin-like Growth Factor-1 Receptor (IGF1R), specifically by monitoring the ligand-induced recruitment of the intracellular signaling protein SHC1 (Src homology 2 domain-containing transforming protein 1).

A first fusion construct was created, comprising DNA encoding the human IGF-1R, which can be found at GenBank under the Accession Number NM_{—}000875 (SEQ ID NO: 96), fused in frame to a DNA sequence encoding amino acids 3-335 of the tetracycline-controlled transactivator tTA, described supra. Inserted between these sequences is a DNA sequence encoding the amino acid sequence GSENLYFQL (SEQ ID NO: 82) which includes the low efficiency cleavage site for TEV NIa-Pro, ENLYFQL (SEQ ID NO: 14), described supra. The CMV promoter was placed upstream of the IGF1R coding region, and a polyA sequence was placed downstream of the tTA region. This construct is designated IGF1R-TEV-NIa-Pro cleavage (Leu)-tTA.

A second fusion construct was created, comprising DNA encoding the PTB domain of human SHC1, corresponding to amino acids 1-238 (GeneBank accession number BC014158) (SEQ ID NO: 97) fused in frame to a DNA sequence encoding the catalytic domain of mature TEV NIa protease, described supra, corresponding to amino acids 2040-2279 (GeneBank accession number AAA47910) (SEQ ID NO: 79). Inserted between these sequences is a linker DNA sequence encoding the amino acids NSGS (SEQ ID NO: 98). The CMV promoter was placed upstream of the SHC1 PTB domain coding sequence and a polyA sequence was placed downstream of the TEV NIa protease sequence. This construct is designated SHC1-TEV.

The IGF1R-TEV-NIa-Pro cleavage (Leu)-tTA and SHC1-TEV fusion constructs were transfected into clone HTL5B8.1 cells described supra. About 2.5×10⁴ cells were plated into each well of a 96 well-plate, in DMEM medium supplemented with 10% fetal bovine serum, 2 mM L-Glutamine, 100 units/ml penicillin, 500 μg/ml G418, and 3 μg/ml puromycin. Cells were grown to reach 50% confluency the next day and were transfected with 15 μl per well of a mixture consisting of 100 μl of DMEM, 0.2 μg of IGF1R-TEV-NIa-Pro cleavage (Leu)-tTA DNA, 0.2 μg of SHC1-TEV DNA, and 2 μl Fugene (a proprietary transfection reagent containing lipids and other material), which had been incubated for 15 minutes at room temperature prior to addition to the cells. Transfected cells were cultured for about 16 hours before treatment with a specific receptor agonist. After 24 hours, cells were lysed and luciferase activity was assayed as described supra.

The addition of 1 μM human Insulin-like Growth Factor 1 resulted in a 90 fold increase of luciferase reporter gene activity.

### Example 29

This experiment was designed to demonstrate the use of the assay to measure the interaction of two test proteins that are not normally membrane bound. In this example, the assay was used to measure the ligand-induced dimerization of the nuclear steroid hormone receptors, ESR1 (estrogen receptor 1 or ER alpha) and ESR2 (estrogen receptor 2 or ER beta). In this example, ESR1 is fused to the transcription factor tTA, where the cleavage site for the TEV NIa-Pro protease is inserted between the ESR1 and tTA sequences. This ESR1-tTA fusion is tethered to the membrane by a fusion to the intracellular, C-terminal end of the transmembrane protein CD8. CD8 essentially serves as an inert scaffold that tethers ESR1 to the cytoplasmic side of the cell membrane. The transcription factor fused thereto cannot enter the nucleus until interaction with ESR2 and protease. Any transmembrane protein could be used. This CD8-ESR1-TEV NIa Pro cleavage-tTA fusion protein is expressed together with a second fusion protein comprised of ESR2 and the TEV NIa-Pro protease in a cell line containing a tTA-dependent reporter gene. The estrogen-induced dimerization of ESR1 and ESR2 thereby triggers the release of the tTA transcription factor from the membrane bound fusion, which is detected by the subsequent induction in reporter gene activity.

A fusion construct was created, comprising DNA encoding human CD8 gene (235 amino acids), which can be found in Genbank under Accession Number NM_{—}001768 (SEQ ID NO: 99), fused in frame to a DNA sequence encoding the human ESR1 (596 amino acids), which can be found in Genbank under Accession Number NM_{—}000125 (SEQ ID NO: 100). Inserted between these sequences is a DNA sequence encoding the amino acid sequence GRA (Gly-Arg-Ala). The resulting construct is then fused in frame to a DNA sequence encoding amino acids 3-335 of the tetracycline controlled transactivator tTA, described supra. Inserted between these sequences is a DNA sequence encoding the amino acid sequence GSENLYFQL (SEQ ID NO: 82) which includes the low efficiency cleavage site for TEV NIa-Pro, ENLYFQL (SEQ ID NO: 14), described supra. The CMV promoter was placed upstream of the Human CD8 coding region, and a poly A sequence was placed downstream of the tTA region. This construct is designated CD8-ESR1-TEV-NIa-Pro cleavage (L)-tTA.

A second fusion construct was created, using DNA encoding Human Estrogen Receptor beta (ESR2) (530 amino acids), which can be found at Genbank, under Accession Number NM_{—}001437 (SEQ ID NO: 101), fused in frame to a DNA sequence encoding the catalytic domain of the TEV NIa protease, described supra, corresponding to amino acids 2040-2279 (GenBank accession number AAA47910) (SEQ ID NO: 84). Inserted between these sequences is a DNA sequence encoding the amino acid sequence RS (Arg-Ser). The CMV promoter region was placed upstream of the Human Estrogen Receptor beta (ESR2) coding region, and a poly A sequence was placed downstream of the TEV region. This construct is designated ESR2-TEV.

The CD8-ESR1-TEV-NIa-Pro cleavage (L)-tTA and ESR2-TEV fusion constructs, together with pcDNA3 were transiently transfected into HTL5B8.1 cells described supra. About 2.0×10⁴ cells were seeded in each well of a 96 well plate and cultured in phenol-free DMEM medium supplemented with 10% fetal bovine serum, 2 mM L-glutamine, 100 units/ml penicillin, 100 μg/ml G418, and 5 μg/ml puromycin. After 24 hours of incubation, cells were transfected with a mixture of 5 ng of ESR1-TEV-NIa-Pro cleavage (L)-tTA, 15 ng of ESR2-TEV and 40 ng of pcDNA3, together with 0.3 μl Fugene per well. 6 hours after transfection, the cells were washed with PBS and incubated in 100 μl of phenol-free DMEM without serum for 24 hours before treatment with 50 nM 17-β Estradiol. Ligand-treated cells were cultured for an additional 18-20 hours before they were assayed for luciferase reporter gene activity as described supra. Treatment with 50 nM 17-β Estradiol resulted in a 16-fold increase in reporter gene activity.

### Example 30

As discussed, supra, a multiplex array is prepared, using a solid substrate, such as a multiwell plate, where each well contains a sample of cells transformed or transfected in accordance with the invention, each of which presents a different, first test protein, as discussed herein.

As noted, supra, the test proteins are preferably receptors, such as GPCRs. They are most preferably selected from the following, set forth in Tables 1 and 2.

TABLE 1

| receptor | | | Genbank |
|---|---|---|---|
| name | alternate names | family | GeneID |
| ADORA1 | RDC7, adenosine A1 receptor | adenosine | 134 |
| ADORA2A | RDC8, hA2aR, ADORA2, adenosine A2a receptor | adenosine | 135 |
| ADORA3 | A3AR, adenosine A3 receptor | adenosine | 140 |
| ADRA1A | ADRA1C, ADRA1L1 | adrenergic | 148 |
| ADRA1B | ADRA1, alpha-1B-adrenergic receptor | adrenergic | 147 |
| ADRA2A | ADRA2, ADRAR, ZNF32, ADRA2R, alpha-2A- | adrenergic | 150 |
| | adrenergic receptor | | |
| ADRA2B | ADRA2L1, ADRARL1, ADRA2RL1, alpha-2B-adrenergic | adrenergic | 151 |
| | receptor | | |
| ADRA2C | ADRA2L2, ADRARL2, ADRA2RL2, ALPHA2CAR, | adrenergic | 152 |
| | alpha-2C-adrenergic receptor, alpha2-AR-C4 | | |
| ADRB1 | RHR, B1AR, ADRB1R, beta-1-adrenergic receptor | adrenergic | 153 |
| ADRB2 | BAR, B2AR, ADRBR, ADRB2R, beta 2 adrenergic | adrenergic | 154 |
| | receptor | | |
| AGTR1 | AT1, AG2S, AT1B, AT2R1, HAT1R, AGTR1A, AGTR1B, | angiotensin | 185 |
| | AT2R1A, AT2R1B, angiotensin II receptor, type 1 | | |
| AGTRL1 | APJ, MGC45246, angiotensin II receptor-like 1, APJR | angiotensin | 187 |
| AVPR2 | DI1, DIR, NDI, V2R, ADHR | vasopressin | 554 |
| BDKRB2 | B2R, BK2, BK-2, BKR2, BRB2, bradykinin receptor B2 | bradykinin | 624 |
| CALCRL | CRLR, CGRPR, calcitonin receptor-like | calcitonin | 10203 |
| (+RAMP1) | | | |
| CCR1 | CKR-1, HM145, CMKBR1, MIP1aR, RANTES receptor | chemokine | 1230 |
| CCR5 | CKR5, CD195, CKR-5, CCCKR5, CMKBR5, CC-CKR-5, | chemokine | 1234 |
| | chemokine (C-C motif) receptor 5 | | |
| CHRM1 | M1, HM1, MGC30125, muscarinic acetylcholine | acetylcholine | 1128 |
| | receptor M1 | | |
| CHRM2 | HM2, muscarinic acetylcholine receptor M2 | acetylcholine | 1129 |
| CHRM4 | HM4, cholinergic receptor, muscarinic 4 | acetylcholine | 1132 |
| CHRM5 | HM5, MGC41838, cholinergic receptor, muscarinic 5 | acetylcholine | 1133 |
| CNR1 | CB1, CNR, CB-R, CB1A, CANN6, CB1K5, | cannabanoid | 1268 |
| CRHR1 | CRF1, CRHR, CRF-R, CRFR1, corticotropin releasing | corticotropin | 1394 |
| | hormone receptor 1 | releasing | |
| | | hormone | |
| DRD1 | DADR, DRD1A, D1 | dopamine | 1812 |
| DRD2 | D2R, D2DR, D2 | dopamine | 1813 |
| DRD3 | D3DR | dopamine | 1814 |
| EDNRA | ETA, ETRA, endothelin receptor type A | endothelin | 1909 |
| EDNRB | ETB, ETRB, HSCR, ABCDS, HSCR2, endothelin | endothelin | 1910 |
| | receptor type B, Hirschsprung disease 2 | | |
| F2R | TR, CF2R, PAR1, coagulation factor II receptor | coagulation | 2149 |
| | precursor | factor/thrombin | |
| F2RL1 | PAR2, GPR11, coagulation factor II (thrombin) receptor- | coagulation | 2150 |
| | like 1 precursor | factor/thrombin | |
| GHSR | growth hormone secretagogue receptor isoform 1a | ghrelin, motilin | 2693 |
| GRPR | gastrin-releasing peptide receptor | bombesin | 2925 |
| HCRTR1 | OX1R, orexin receptor | orexin | 3061 |
| HRH1 | H1-R, hisH1, histamine receptor H1, histamine receptor, | histamine | 3269 |
| | subclass H1 | | |
| HRH2 | H2R, histamine receptor H2, gastric receptor 1 | histamine | 3274 |
| HRH3 | HH3R, GPCR97, histamine receptor H3, G protein- | histamine | 11255 |
| | coupled receptor 97 | | |
| HTR1A | ADRBRL1, ADRB2RL1 | serotonin | 3350 |
| HTR1B | S12, HTR1D2, HTR1DB, 5-HT1B, 5-HT1DB | serotonin | 3351 |
| HTR2A | HTR2, 5-hydroxytryptamine (serotonin) receptor 2A | serotonin | 3356 |
| HTR2B | 5-HT2B, 5-HT(2B), 5-hydroxytryptamine (serotonin) | serotonin | 3357 |
| | receptor 2B | | |
| HTR2C | HTR1C | serotonin | 3358 |
| (non-edited | | | |
| INI) | | | |
| HTR2C | HTR1C | serotonin | 3358 |
| (edited VGV) | | | |
| HTR4 | 5-hydroxytryptamine (serotonin) receptor 4 | serotonin | 3360 |
| HTR5A | 5-hydroxytryptamine (serotonin) receptor 5A | serotonin | 3361 |
| HTR6 | 5-hydroxytryptamine (serotonin) receptor 6 | serotonin | 3362 |
| IL8RB | CXCR2, IL8R2, IL8RA, CMKAR2, CDw128b, interleukin | chemokine | 3579 |
| | 8 receptor beta, GRO/MGSA receptor | | |
| MC4R | melanocortin 4 receptor | melanocortin | 4160 |
| MLNR | MTLR1, G protein-coupled receptor 38, MLNR1, GPR38 | ghrelin, motilin | 2862 |
| NPY2R | neuropeptide Y receptor Y2 | neuropeptide Y | 4887 |
| NTSR1 | NTR, neurotensin receptor 1 | neurotensin | 4923 |
| OPRK1 | KOR, OPRK, KOP, kappa opioid receptor | opioid | 4986 |
| OPRL1 | OOR, ORL1, KOR-3, NOCIR, MGC34578, opiate | opioid | 4987 |
| | receptor-like 1 | | |
| OPRM1 | OPRM, MOR-1, mu opioid receptor | opioid | 4988 |
| SALPR | G-protein coupled receptor SALPR, somatostatin and | Orphan | 51289 |
| | angiotensin-like peptide receptor, GPCR135 | | |
| SSTR5 | somatostatin receptor 5 | somatostatin | 6755 |
| TACR1 | SPR, NK1R, NKIR, TAC1R | tachykinin | 6869 |
| TACR2 | SKR, NK2R, NKNAR, TAC2R, NK-2 receptor | tachykinin | 6865 |
| TRHR | thyrotropin-releasing hormone receptor | | 7201 |

and even more preferably, are chosen from the alternative presented in Table 2.

TABLE 2

| ADCYAP1R1 | PACAPR, PACAPRI | | 117 |
|---|---|---|---|
| ADMR | AMR, 7TMR, hrhAMR, adrenomedullin receptor | adrenomedullin | 11318 |
| ADORA1 | RDC7, adenosine A1 receptor | adenosine | 134 |
| ADORA2A | RDC8, hA2aR, ADORA2, adenosine A2a receptor | adenosine | 135 |
| ADORA2B | ADORA2, adenosine A2b receptor | adenosine | 136 |
| ADORA3 | A3AR, adenosine A3 receptor | adenosine | 140 |
| ADRA1A | ADRA1C, ADRA1L1 | adrenergic | 148 |
| ADRA1B | ADRA1, alpha-1B-adrenergic receptor | adrenergic | 147 |
| ADRA1D | ADRA1, ADRA1A, ADRA1R, alpha-1D-adrenergic | adrenergic | 146 |
| | receptor | | |
| ADRA2A | ADRA2, ADRAR, ZNF32, ADRA2R, alpha-2A- | adrenergic | 150 |
| | adrenergic receptor | | |
| ADRA2B | ADRA2L1, ADRARL1, ADRA2RL1, alpha-2B-adrenergic | adrenergic | 151 |
| | receptor | | |
| ADRA2C | ADRA2L2, ADRARL2, ADRA2RL2, ALPHA2CAR, | adrenergic | 152 |
| | alpha-2C-adrenergic receptor, alpha2-AR-C4 | | |
| ADRB1 | RHR, B1AR, ADRB1R, beta-1-adrenergic receptor | adrenergic | 153 |
| ADRB2 | BAR, B2AR, ADRBR, ADRB2R, beta 2 adrenergic | adrenergic | 154 |
| | receptor | | |
| ADRB3 | adrenergic, beta-3-, receptor | adrenergic | 155 |
| AGTR1 | AT1, AG2S, AT1B, AT2R1, HAT1R, AGTR1A, AGTR1B, | angiotensin | 185 |
| | AT2R1A, AT2R1B, angiotensin II receptor, type 1 | | |
| AGTR2 | AT2, angiotensin II receptor, type 2 | angiotensin | 186 |
| AGTRL1 | APJ, MGC45246, angiotensin II receptor-like 1, APJR | angiotensin | 187 |
| AVPR1A | arginine vasopressin receptor 1A | vasopressin | 552 |
| AVPR1B | arginine vasopressin receptor 1B | vasopressin | 553 |
| AVPR2 | DI1, DIR, NDI, V2R, ADHR | vasopressin | 554 |
| BAI1 | brain-specific angiogenesis inhibitor 1 precursor | Orphan B1 | 575 |
| BAI2 | brain-specific angiogenesis inhibitor 2 | Orphan B1 | 576 |
| BAI3 | KIAA0550, brain-specific angiogenesis inhibitor 3 | Orphan B1 | 577 |
| BDKRB1 | B1R, BKR1, B1BKR, BRADYB1, bradykinin receptor B1 | bradykinin | 623 |
| BDKRB2 | B2R, BK2, BK-2, BKR2, BRB2, bradykinin receptor B2 | bradykinin | 624 |
| BLP1 | BBP-like protein 1 | | 83877 |
| BLR1 | CXCR5, MDR15, monocyte-derived receptor 15, C—X—C | chemokine | 643 |
| | chemokine receptor type 5, Burkitt lymphoma receptor 1 | | |
| BRS3 | bombesin-like receptor 3 | bombesin | 680 |
| C3AR1 | AZ3B, C3AR, HNFAG09, complement component 3a | complement | 719 |
| | receptor 1 | component 5a | |
| C5R1 | C5A, C5AR, CD88, complement component 5 receptor 1 | complement | 728 |
| | (C5a ligand) | component 5a | |
| CALCR | CRT, CTR, CTR1, calcitonin receptor | calcitonin | 799 |
| CALCRL | CRLR, CGRPR, calcitonin receptor-like | calcitonin | 10203 |
| CASR | FHH, HHC, HHC1, NSHPT, PCAR1, GPRC2A, calcium- | | 846 |
| | sensing receptor | | |
| CCBP2 | D6, CCR9, CCR10, CMKBR9, hD6, chemokine binding | chemokine | 1238 |
| | protein 2 | | |
| CCKAR | cholecystokinin A receptor | cholecystokinin, | 886 |
| | | CCK | |
| CCKBR | CCK2 receptor, gastrin receptor, GASR, cholecystokinin | cholecystokinin, | 887 |
| | B receptor | CCK | |
| CCR1 | CKR-1, HM145, CMKBR1, MIP1aR, RANTES receptor | chemokine | 1230 |
| CCR2 | CKR2, CCR2A, CCR2B, CKR2A, CKR2B, CMKBR2, | chemokine | 1231 |
| | MCP-1-R, CC-CKR-2, chemokine (C-C) receptor 2 | | |
| CCR3 | CKR3, CMKBR3, CC-CKR-3, CC chemokine receptor 3 | chemokine | 1232 |
| CCR4 | CKR4, k5-5, CMKBR4, ChemR13, CC-CKR-4, | chemokine | 1233 |
| | HGCN: 14099, chemokine (C-C motif) receptor 4 | | |
| CCR5 | CKR5, CD195, CKR-5, CCCKR5, CMKBR5, CC-CKR-5, | chemokine | 1234 |
| | chemokine (C-C motif) receptor 5 | | |
| CCR6 | BN-1, CKR6, DCR2, CKRL3, DRY-6, GPR29, CKR-L3, | chemokine | 1235 |
| | CMKBR6, GPRCY4, STRL22, GPR-CY4, chemokine (C- | | |
| | C motif) receptor 6 | | |
| CCR7 | BLR2, EBI1, CDw197, CMKBR7, chemokine (C-C motif) | chemokine | 1236 |
| | receptor 7 precursor | | |
| CCR8 | CY6, TER1, CKRL1, CKR-L1, CMKBR8, CMKBRL2, | chemokine | 1237 |
| | GPR-CY6 | | |
| CCR9 | GPR-9-6 | chemokine | 10803 |
| CCRL1 | PPR1, CCBP2, CCR10, CCR11, VSHK1, CKR-11, CCX- | chemokine | 51554 |
| | CKR, CC-CKR-11, chemokine (C-C motif) receptor-like 1 | | |
| CCRL2 | HCR, CKRX, CRAM-A, CRAM-B, chemokine (C-C motif) | chemokine | 9034 |
| | receptor-like 2 | | |
| CD97 | TM7LN1, leukocyte antigen CD97 | | 976 |
| CELSR1 | ME2, FMI2, CDHF9, HFMI2, cadherin EGF LAG seven- | proto-cadherin, | 9620 |
| | pass G-type receptor 1, protocadherin flamingo 2 | Orphan B2 | |
| CELSR2 | EGFL2, MEGF3, CDHF10, KIAA0279, Flamingo1, | proto-cadherin, | 1952 |
| | cadherin EGF LAG seven-pass G-type receptor 2 | Orphan B2 | |
| CELSR3 | FMI1, EGFL1, HFMI1, MEGF2, CDHF11, cadherin EGF | proto-cadherin, | 1951 |
| | LAG seven-pass G-type receptor 3 | Orphan B2 | |
| CHRM1 | M1, HM1, MGC30125, muscarinic acetylcholine receptor | acetylcholine | 1128 |
| | M1 | | |
| CHRM2 | HM2, muscarinic acetylcholine receptor M2 | acetylcholine | 1129 |
| CHRM3 | HM3, cholinergic receptor, muscarinic 3 | acetylcholine | 1131 |
| CHRM4 | HM4, cholinergic receptor, muscarinic 4 | acetylcholine | 1132 |
| CHRM5 | HM5, MGC41838, cholinergic receptor, muscarinic 5 | acetylcholine | 1133 |
| CMKLR1 | DEZ, ChemR23, chemokine-like receptor 1 | chemokine | 1240 |
| CMKOR1 | RDC1, GPR159 | | 57007 |
| CNR1 | CB1, CNR, CB-R, CB1A, CANN6, CB1K5, | cannabanoid | 1268 |
| CNR2 | CB2, CX5, cannabinoid receptor 2 (macrophage) | cannabanoid | 1269 |
| CRHR1 | CRF1, CRHR, CRF-R, CRFR1, corticotropin releasing | corticotropin | 1394 |
| | hormone receptor 1 | releasing | |
| | | hormone | |
| CRHR2 | CRFR2, corticotropin releasing hormone receptor 2 | corticotropin | 1395 |
| | | releasing | |
| | | hormone | |
| CX3CR1 | V28, CCRL1, GPR13, CMKDR1, GPRV28, CMKBRL1, | chemokine | 1524 |
| | chemokine (C-X3-C motif) receptor 1 | | |
| CXCR3 | GPR9, IP10, MigR, CD183, Mig-R, CKR-L2, CMKAR3, | chemokine | 2833 |
| | IP10-R, chemokine (C—X—C motif) receptor 3 | | |
| CXCR4 | HM89, LAP3, NPYR, WHIM, LESTR, NPY3R, fusin, | chemokine | 7852 |
| | HSY3RR, NPYY3R, D2S201E, chemokine (C—X—C motif) | | |
| | receptor 4 | | |
| CXCR6 | BONZO, STRL33, TYMSTR, G protein-coupled receptor | chemokine | 10663 |
| | TYMSTR | | |
| CYSLT1 | HG55, CYSLT1, CYSLTR, CYSLT1R, HMTMF81, | cysteinyl | 10800 |
| | MGC46139, cysteinyl leukotriene receptor 1 | leukotriene | |
| CYSLT2 | GPCR, HG57, CYSLT2, HPN321, CYSLT2R, | cysteinyl | 57105 |
| | hGPCR21, PSEC0146, cysteinyl leukotriene receptor 2 | leukotriene | |
| DDR1 | CAK, DDR, NEP, PTK3, RTK6, TRKE, CD167, EDDR1, | | 780 |
| | MCK10, NTRK4, PTK3A | | |
| DJ287G14 | | | |
| DRD1 | DADR, DRD1A, D1 | dopamine | 1812 |
| DRD2 | D2R, D2DR, D2 | dopamine | 1813 |
| DRD3 | D3DR | dopamine | 1814 |
| DRD4 | D4DR, dopamine receptor D4, D(2C) dopamine receptor | dopamine | 1815 |
| DRD5 | DBDR, DRD1B, DRD1L2, MGC10601, dopamine | dopamine | 1816 |
| | receptor D1B, D1beta dopamine receptor | | |
| EBI2 | EBV-induced G protein-coupled receptor 2 | | 1880 |
| EDG1 | ECGF1, CHEDG1, D1S3362, edg-1, sphingosine 1- | sphingolipid | 1901 |
| | phosphate receptor EDG1, G protein-coupled | | |
| | sphingolipid receptor | | |
| EDG2 | LPA1, edg-2, vzg-1, Gpcr26, Mrec1.3, rec.1.3, | sphingolipid | 1902 |
| | endothelial differentiation, lysophosphatidic acid G- | | |
| | protein-coupled receptor, 2 | | |
| EDG3 | LPB3, S1P3, EDG-3, FLJ37523, MGC71696, S1P | sphingolipid | 1903 |
| | receptor EDG3 | | |
| EDG4 | LPA2, EDG-4, endothelial differentiation, | sphingolipid | 9170 |
| | lysophosphatidic acid G-protein-coupled receptor, 4 | | |
| EDG5 | H218, LPB2, S1P2, AGR16, EDG-5, Gpcr13, | sphingolipid | 9294 |
| | lysophosphatidic acid receptor EDG4 | | |
| EDG6 | LPC1, SLP4, endothelial differentiation, lysophosphatidic | sphingolipid | 8698 |
| | acid G-protein-coupled receptor, 4 | | |
| EDG7 | GPCR, Edg-7, LP-A3, HOFNH30, RP4-678I3, | sphingolipid | 23566 |
| | endothelial differentiation, lysophosphatidic acid G- | | |
| | protein-coupled receptor, 7 | | |
| EDG8 | S1P5, Edg-8, SPPR-1, SPPR-2, endothelial | sphingolipid | 53637 |
| | differentiation, sphingolipid G-protein-coupled receptor, | | |
| EDNRA | ETA, ETRA, endothelin receptor type A | endothelin | 1909 |
| EDNRB | ETB, ETRB, HSCR, ABCDS, HSCR2, endothelin | endothelin | 1910 |
| | receptor type B, Hirschsprung disease 2 | | |
| ELTD1 | EGF-TM7-latrophilin-related protein, ETL | Orphan B3 | 64123 |
| EMR1 | egf-like module containing, mucin-like, hormone | Orphan B3B | 2015 |
| | receptor-like | | |
| EMR2 | egf-like module containing, mucin-like, hormone | Orphan B3B | 30817 |
| | receptor-like sequence 2 | | |
| EMR3 | egf-like module-containing mucin-like receptor 3 | Orphan B3B | 84658 |
| EMR4 | PGR16, GPR127, EGF-TM7 receptor EMR4 | Orphan B3B | 326342 |
| F2R | TR, CF2R, PAR1, coagulation factor II receptor | coagulation | 2149 |
| | precursor | factor/thrombin | |
| F2RL1 | PAR2, GPR11, coagulation factor II (thrombin) receptor- | coagulation | 2150 |
| | like 1 precursor | factor/thrombin | |
| F2RL2 | PAR3, coagulation factor II (thrombin) receptor-like 2 | coagulation | 2151 |
| | precursor | factor/thrombin | |
| F2RL3 | PAR4, coagulation factor II (thrombin) receptor-like 3 | coagulation | 9002 |
| | | factor/thrombin | |
| FKSG79 | putative purinergic receptor FKSG79 | orphan A13 | 84636 |
| | | family | |
| FPR1 | FPR, FMLP, formyl peptide receptor 1 | formyl peptide | 2357 |
| FPRL1 | ALXR, HM63, FMLPX, FPR2A, FPRH1, FPRH2, | formyl peptide | 2358 |
| | LXA4R, FMLP-R-II, formyl peptide receptor-like 1, | | |
| | lipoxin A4 receptor | | |
| FPRL2 | FMLPY, FPRH1, FPRH2, RMLP-R-l, formyl peptide | formyl peptide | 2359 |
| | receptor-like 2 | | |
| FSHR | LGR1, ODG1, FSHRO, FSH receptor, follitropin | follicle | 2492 |
| | receptor, ovarian dysgenesis 1 | stimulating | |
| | | hormone | |
| FY | GPD, DARC, CCBP1, Duffy blood group | | 2532 |
| FZD1 | frizzled 1 | frizzled | 8321 |
| FZD10 | FzE7, FZ-10, hEz10, frizzled 10 | frizzled | 11211 |
| FZD2 | frizzled 2 | frizzled | 2535 |
| FZD3 | frizzled 3, Fz-3, hFz3 | frizzled | 7976 |
| FZD4 | EVR1, Fz-4, FzE4, GPCR, FZD4S, MGC34390, frizzled 4 | frizzled | 8322 |
| FZD5 | frizzled 5, HFZ5 | frizzled | 7855 |
| FZD6 | frizzled 6, Hfz6 | frizzled | 8323 |
| FZD7 | FzE3, frizzled 7 | frizzled | 8324 |
| FZD8 | FZ-8, hFZ8, frizzled 8 | frizzled | 8325 |
| FZD9 | frizzled 9 | frizzled | 8326 |
| GABBR1 | GPRC3A, GABABR1, hGB1a, GABAB(1e), | GABA-B | 2550 |
| | dJ271M21.1.1, dJ271M21.1.2, GABA-B receptor, | | |
| | GABAB, subunit 1c | | |
| GALR1 | GALNR, GALNR1, galanin receptor 1 | galanin | 2587 |
| GALR2 | GALNR2, galanin receptor 2 | galanin | 8811 |
| GALR3 | galanin receptor 3, galanin receptor, family member 3 | galanin | 8484 |
| GCGR | GGR, glucagon receptor | glucagon | 2642 |
| GHRHR | GHRFR, growth hormone releasing hormone receptor | gonadotropin- | 2692 |
| | | releasing | |
| | | hormone | |
| GHSR(1a) | growth hormone secretagogue receptor isoform 1a | ghrelin | 2693 |
| GHSR(1b) | growth hormone secretagogue receptor isoform 1b | ghrelin | 2693 |
| GIPR | gastric inhibitory polypeptide receptor | | 2696 |
| GLP1R | glucagon-like peptide 1 receptor | glucagon-like | 2740 |
| GLP2R | glucagon-like peptide 2 receptor precursor | glucagon | 9340 |
| GNRHR | GRHR, LHRHR, gonadotropin-releasing hormone | GNRH | 2798 |
| | receptor (leutinizing-releasing hormone receptor) | | |
| GNRHR2 | gonadotropin-releasing hormone (type 2) receptor 2 | GNRH | 114814 |
| GPR | AGR9, S53525 | Orphan A2 (ish) | 11245 |
| GPR1 | G protein-coupled receptor 1 | | 2825 |
| GPR10 | GR3, PrRPR, G protein-coupled receptor 10 | | 2834 |
| GPR100 | HGPCR11, GPCR142, relaxin-3 receptor-2 | Orphan A10 | 339403 |
| | | group | |
| GPR101 | GPCR6, G protein-coupled receptor 101 | | 83550 |
| GPR103 | AQ27, SP9155, QRFP receptor, G protein-coupled | | 84109 |
| | receptor 103 | | |
| GPR105 | KIAA0001, G protein-coupled receptor 105, G protein | ADP/UDP- | 9934 |
| | coupled receptor for UDP-glucose, P2Y14 | glucose | |
| GPR108 | LUSTR2 | | 56927 |
| GPR109A | HM74b, G protein-coupled receptor HM74a, HM74a | | 338442 |
| GPR109B | PUMAG, HM74 | | 8843 |
| GPR110 | PGR19, hGPCR36, G-protein coupled receptor 110 | Orphan B4 | 266977 |
| GPR111 | PGR20 | Orphan B4 | 222611 |
| GPR112 | PGR17 | | 139378 |
| GPR113 | PGR23 | Orphan B4 | 165082 |
| GPR114 | PGR27 | | 221188 |
| GPR115 | PGR18, FLJ38076, G-protein coupled receptor 115 | Orphan B4 | 221393 |
| GPR116 | KIAA0758 | Orphan B4 | 221395 |
| GPR119 | HGPCR2 | | 139760 |
| GPR12 | PGR4, G protein-coupled receptor 120 | relaxin/insl3 | 338557 |
| GPR12 | GPCR21, G protein-coupled receptor 12 | | 2835 |
| GPR123 | KIAA1828 | | 84435 |
| GPR124 | TEM5 | | 25960 |
| GPR125 | PGR21 | | 166647 |
| GPR128 | G protein-coupled receptor 128, FLJ14454 | | 84873 |
| GPR132 | G2A | | 29933 |
| GPR133 | PGR25 | | 283383 |
| GPR135 | PAFR, HUMNPIIY20 | | 64582 |
| GPR139 | PGR3, LOC124274 | | 124274 |
| GPR141 | PGR13 | | 353345 |
| GPR142 | PGR2 | | 350383 |
| GPR143 | OA1 | | 4935 |
| GPR144 | PGR24 | | 347088 |
| GPR145 | SLT, MCH2, MCH2R, MCHR2 | mch, melanin- | 84539 |
| | | concentrating | |
| | | hormone | |
| GPR146 | PGR8 | | 115330 |
| GPR147 | NPFF1, NPFF1R1, OT7T022 | neuropeptide ff | 64106 |
| GPR148 | PGR6 | | 344561 |
| GPR149 | PGR10 | | 344758 |
| GPR15 | G protein-coupled receptor 15 | | 2838 |
| GPR150 | PGR11, G protein-coupled receptor 150 | orphan | 387128 |
| GPR151 | PGR7, galanin receptor-like putative G protein-coupled | | 134391 |
| | receptor | | |
| GPR152 | PGR5 | | 387127 |
| GPR153 | PGR1 | Orphan A9 | 387509 |
| | | group | |
| GPR154 | PGR14, G protein-coupled receptor 154, VRR1, GPRA | vasopressin | 387129 |
| | | (ish) | |
| GPR155 | PGR22 | | 151556 |
| GPR156 | PGR28 | | 165829 |
| GPR160 | GPCR1, GPCR150 | | 26996 |
| GPR161 | G protein-coupled receptor 161, RE2 | orphan | 23432 |
| GPR17 | G protein-coupled receptor 17 | | 2840 |
| GPR171 | H963 | | 29909 |
| GPR18 | G protein-coupled receptor 18 | | 2841 |
| GPR18 | G protein-coupled receptor 19 | | 2842 |
| GPR2 | CCR10, CC chemokine receptor 10 | chemokine, | 2826 |
| | | orphan | |
| GPR20 | G protein-coupled receptor 20 | | 2843 |
| GPR21 | G protein-coupled receptor 21 | Orphan A2 | 2844 |
| GPR22 | G protein-coupled receptor 22 | Orphan A2 (ish) | 2845 |
| GPR23 | P2Y9, P2Y5-LIKE, G protein-coupled receptor 23 | Orphan A12 | 2846 |
| | | group | |
| GPR24 | SLC1, MCHR1, MGC32129, melanin-concentrating | mch, melanin- | 2847 |
| | hormone receptor 1, G protein-coupled receptor 24 | concentrating | |
| | | hormone | |
| GPR25 | G protein-coupled receptor 25 | | 2848 |
| GPR26 | G protein-coupled receptor 26 | Orphan A3 | 2849 |
| | | group | |
| GPR27 | SREB1, G protein-coupled receptor 27 | SREB | 2850 |
| GPR3 | ACCA, G protein-coupled receptor 3, adenylate cyclase | | 2827 |
| | constitutive activator | | |
| GPR30 | FEG-1, CMKLR2, GPCR-Br, G protein-coupled receptor | | 2852 |
| | 30, chemokine receptor-like 2 | | |
| GPR31 | G protein-coupled receptor 31 | | 2853 |
| GPR32 | G protein-coupled receptor 32 | | 2854 |
| GPR34 | GPCR, G protein-coupled receptor 34 | | 2857 |
| GPR35 | G protein-coupled receptor 35 | | 2859 |
| GPR37 | PAELR, EDNRBL, hET(B)R-LP, G protein-coupled | Orphan A4 | 2861 |
| | receptor 37, endothelin receptor type B-like | group | |
| GPR37L1 | ETBR-LP-2 | Orphan A4 | 80983 |
| | | group | |
| GPR39 | G protein-coupled receptor 39 | | 2863 |
| GPR4 | G protein-coupled receptor 4 | | 2828 |
| GPR40 | G protein-coupled receptor 40 | | 2864 |
| GPR41 | G protein-coupled receptor 41 | orphan A5 | 2865 |
| GPR43 | FFA2R, free fatty acid activated receptor 2, G protein- | orphan A5 | 2867 |
| | coupled receptor 43 | | |
| GPR44 | CRTH2, chemoattractant receptor-homologous molecule expressed on | | 11251 |
| | TH2 cells, G protein-coupled receptor 44 | | |
| GPR45 | PSP24A, PSP24 (ALPHA), high-affinity lysophosphatidic | Orphan A6 | 11250 |
| | acid receptor, G protein-coupled receptor 45 | group | |
| GPR48 | LGR4, G protein-coupled receptor 48 | LGR | 55366 |
| GPR49 | FEX, HG38, LGR5, GPR67, GRP49, G protein-coupled | LGR | 8549 |
| | receptor 49 | | |
| GPR50 | G protein-coupled receptor 50, H9 | melatonin (ish) | 9248 |
| GPR51 | HG20, GABBR2, GPRC3B, GABABR2, G protein- | GABA-B | 9568 |
| | coupled receptor 51 | | |
| GPR52 | G protein-coupled receptor 52 | Orphan A2 | 9293 |
| GPR54 | | | 84634 |
| GPR55 | | | 9290 |
| GPR56 | | | 9289 |
| GPR57 | | trace amine | 9288 |
| GPR58 | | trace amine | 9287 |
| GPR6 | | | 2830 |
| GPR61 | BALGR, GPCR3 | | 83873 |
| GPR62 | | | 118442 |
| GPR63 | PSP24B | Orphan A6 | 81491 |
| | | group | |
| GPR64 | HE6; TM7LN2 | | 10149 |
| GPR65 | | | 8477 |
| GPR68 | Ovarian cancer G protein-coupled receptor 1, OGR1 | | 8111 |
| GPR7 | | neuropeptide w | 2831 |
| GPR73 | ZAQ; PKR1; GPR73a | prokineticin 2 | 10887 |
| GPR73L1 | PKR2; GPRg2; GPR73b; dJ680N4.3 | prokineticin 2 | 128674 |
| GPR74 | NPFF2, NPGPR | neuropeptide ff | 10886 |
| GPR75 | | | 10936 |
| GPR77 | C5L2 | complement | 27202 |
| | | component 5a | |
| GPR78 | | Orphan A3 | 27201 |
| | | group | |
| GPR8 | | neuropeptide w | 2832 |
| GPR80 | GPR99, OXGR1 | | 27199 |
| GPR81 | FKSG80 | eicosanoid | 27198 |
| GPR82 | | | 27197 |
| GPR83 | GIR, GPR72, JP05 | | 10888 |
| GPR84 | EX33 | | 53831 |
| GPR85 | SREB2 | SREB | 54329 |
| GPR87 | GPR95 | ADP/UDP- | 53836 |
| | | glucose | |
| GPR88 | STRG | | 54112 |
| GPR91 | | | 56670 |
| GPR92 | Bach (Paradigm), GPR93 | | 57121 |
| GPR97 | PGR26, EGF-TM7-like, Pb99, GPR-97 | | 222487 |
| GPRC5B | RAIG2, RAIG-2, retinoic acid responsive gene protein, G protein-coupled | | 51704 |
| | receptor, family C, group 1, member B, G protein-coupled receptor, family | | |
| | C, group 5, member B precursor | | |
| GPRC5C | RAIG3, RAIG-3, retinoic acid responsive gene protein | | 55890 |
| GPRC5D | G protein-coupled receptor, family C, group 5, member D | | 55507 |
| GPRC6A | bA86F4.3, G protein-coupled receptor, family C, group | | 222545 |
| | 6, member A | | |
| GRCA | protein “A” | Orphan A9 | 27239 |
| | | group | |
| GRM1 | GRM1A, mGlu1, GPRC1A, MGLUR1, MGLUR1A, | metabotropic | 2911 |
| | glutamate receptor, metabotropic 1 | glutamate | |
| GRM2 | GLUR2, mGlu2, GPRC1B, MGLUR2, glutamate | metabotropic | 2912 |
| | receptor, metabotropic 2 precursor | glutamate | |
| GRM3 | GLUR3, mGlu3, GPRC1C, MGLUR3, glutamate | metabotropic | 2913 |
| | receptor, metabotropic 3 precursor | glutamate | |
| GRM4 | mGlu4, GPRC1D, MGLUR4, glutamate receptor, | metabotropic | 2914 |
| | metabotropic 4 | glutamate | |
| GRM5 | mGlu5, GPRC1E, MGLUR5, MGLUR5A, MGLUR5B, | metabotropic | 2915 |
| | glutamate receptor, metabotropic 5 | glutamate | |
| GRM6 | mGlu6, GPRC1F, MGLUR6, glutamate receptor, | metabotropic | 2916 |
| | metabotropic 6 precursor | glutamate | |
| GRM7 | GLUR7, mGlu7, GPRC1G, MGLUR7, glutamate | metabotropic | 2917 |
| | receptor, metabotropic 7 | glutamate | |
| GRM8 | GLUR8, mGlu8, GPRC1H, MGLUR8, glutamate | metabotropic | 2918 |
| | receptor, metabotropic 8 precursor | glutamate | |
| GRPR | gastrin-releasing peptide receptor | bombesin | 2925 |
| HCRTR1 | OX1R, orexin receptor | orexin | 3061 |
| HCRTR2 | OX2R | orexin | 3062 |
| HGPCR19 | | | |
| HRH1 | H1-R, hisH1, histamine receptor H1, histamine receptor, | histamine | 3269 |
| | subclass H1 | | |
| HRH2 | H2R, histamine receptor H2, gastric receptor 1 | histamine | 3274 |
| HRH3 | HH3R, GPCR97, histamine receptor H3, G protein- | histamine | 11255 |
| | coupled receptor 97 | | |
| HRH4 | H4, H4R, BG26, HH4R, AXOR35, GPRv53, GPCR105, | histamine | 59340 |
| | histamine H4 receptor | | |
| HTR1A | ADRBRL1, ADRB2RL1 | serotonin | 3350 |
| HTR1B | S12, HTR1D2, HTR1DB, 5-HT1B, 5-HT1DB | serotonin | 3351 |
| HTR1D | HTRL, RDC4, HT1DA, HTR1DA | serotonin | 3352 |
| HTR1E | 5-hydroxytryptamine (serotonin) receptor 1E | serotonin | 3354 |
| HTR1F | MR77, HTR1EL, 5-hydroxytryptamine (serotonin) | serotonin | 3355 |
| | receptor 1F | | |
| HTR2A | HTR2, 5-hydroxytryptamine (serotonin) receptor 2A | serotonin | 3356 |
| HTR2B | 5-HT2B, 5-HT(2B), 5-hydroxytryptamine (serotonin) | serotonin | 3357 |
| | receptor 2B | | |
| HTR2C | HTR1C | serotonin | 3358 |
| HTR4 | 5-hydroxytryptamine (serotonin) receptor 4 | serotonin | 3360 |
| HTR5A | 5-hydroxytryptamine (serotonin) receptor 5A | serotonin | 3361 |
| HTR6 | 5-hydroxytryptamine (serotonin) receptor 6 | serotonin | 3362 |
| HTR7A | serotonin 5-HT-7 receptor isoform a | serotonin | 3363 |
| HTR7B | serotonin 5-HT-7 receptor isoform b | serotonin | 3363 |
| IL8RA | CD128, CXCR1, IL8R1, CMKAR1, IL8RBA, CDw128a, | chemokine | 3577 |
| | C-C CKR-1, C-C-CKR-1, interleukin-8 receptor type 1, | | |
| | interleukin-8 receptor type A | | |
| IL8RB | CXCR2, IL8R2, IL8RA, CMKAR2, CDw128b, interleukin | chemokine | 3579 |
| | 8 receptor beta, GRO/MGSA receptor | | |
| LGR6 | FLJ14471, VTS20631, leucine-rich repeat-containing G | LGR | 59352 |
| | protein-coupled receptor 6 | | |
| LGR7 | leucine-rich repeat-containing G protein-coupled | relaxin/insl3, | 59350 |
| | receptor 7 | LGR | |
| LGR8 | GREAT, GPR106, G protein coupled receptor affecting | relaxin/insl3, | 122042 |
| | testicular descent | LGR | |
| LHCGR | LHR, LCGR, LGR2, lutropin/choriogonadotropin receptor | hormone | 3973 |
| LPHN1 | LEC2, CIRL1, FLJ11939, KIAA0821 | Orphan B3A | 22859 |
| LPHN2 | LEC1, LPHH1, KIAA0786 | Orphan B3A | 23266 |
| LPHN3 | LEC3, KIAA0768 | Orphan B3A | 23284 |
| LTB4R | BLTR, P2Y7, GPR16, LTBR1, P2RY7, CMKRL1, | leukotriene | 1241 |
| | LTB4R1, purinergic receptor P2Y, G-protein coupled, 7, | | |
| | chemokine receptor-like 1 | | |
| LTB4R2 | BLT2, BLTR2, JULF2, leukotriene B4 receptor 2 | leukotriene | 56413 |
| MAS1 | MAS1 oncogene, MAS | MRG | 4142 |
| MAS1L | MRG, MAS-L, dJ994E9.2 | MRG | 116511 |
| MASS1 | FEB4, GPR98, USH2C, VLGR1, KIAA0686, | | 84059 |
| | DKFZp761P0710 | | |
| MC1R | MSH-R, MGC14337, melanocortin 1 receptor, | melanocortin | 4157 |
| | melanotropin receptor | | |
| MC2R | ACTHR, melanocortin 2 receptor, | melanocortin | 4158 |
| MC3R | MC3, melanocortin 3 receptor | melanocortin | 4159 |
| MC4R | melanocortin 4 receptor | melanocortin | 4160 |
| MC5R | melanocortin 5 receptor | melanocortin | 4161 |
| mGPR26 | G protein-coupled receptor 26 | Orphan A3 | 2849 |
| | MURINE RECEPTOR | group | (h) |
| MLNR | MTLR1, G protein-coupled receptor 38, MLNR1, GPR38 | | 2862 |
| MRGPRD | MRGD, mas-related G protein-coupled MRGD | MRG | 116512 |
| | TGR7 | | |
| MRGPRE | MRGE, mas-related G protein-coupled MRGE | MRG | 116534 |
| MRGPRF | MrgF, MGC21621, MAS-related GPR, member | MRG | 219928 |
| MRGPRG | MRGG, G protein-coupled receptor MRGG | MRG | 386746 |
| MRGX1 | G protein-coupled receptor MRGX1 | MRG | 259249 |
| MRGX2 | G protein-coupled receptor MRGX2 | MRG | 117194 |
| MRGX3 | G protein-coupled receptor MRGX3 | MRG | 117195 |
| MRGX4 | G protein-coupled receptor MRGX4 | MRG | 117196 |
| MTNR1A | MEL-1A-R, melatonin receptor type 1A | melatonin | 4543 |
| MTNR1B | MEL-1B-R, melatonin receptor type 1B | melatonin | 4544 |
| NMBR | neuromedin B receptor | bombesin | 4829 |
| NMU1R | GPC-R, NMU1R, (FM-3), GPR66 | Neuromedin U | 10316 |
| NMU2R | FM4, neuromedin U receptor 2 | Neuromedin U | 56923 |
| NPY1R | NPYR, neuropeptide Y receptor Y1 | neuropeptide Y | 4886 |
| NPY2R | neuropeptide Y receptor Y2 | neuropeptide Y | 4887 |
| NPY5R | NPYR5, neuropeptide Y receptor Y5 | neuropeptide Y | 4889 |
| NTSR1 | NTR, neurotensin receptor 1 | neurotensin | 4923 |
| NTSR2 | NTR2, neurotensin receptor, type 2, neurotensin | neurotensin | 23620 |
| | receptor 2 | | |
| OPN1LW | CBP, RCP, CBBM, red cone pigment | opsin | 5956 |
| OPN1MW | CBD, DCB, GCP, CBBM, green cone pigment | opsin | 2652 |
| OPN1SW | BCP, CBT, blue cone pigment | opsin | 611 |
| OPN3 | ERO, ECPN, NMO-1, PANOPSIN, opsin 3 | opsin | 23596 |
| | (encephalopsin) | | |
| OPN4 | MOP, opsin 4 (melanopsin) | opsin | 94233 |
| OPN5 | PGR12, GPR136, TMEM13, dJ402H5.1, neuropsin, | opsin | 221391 |
| | transmembrane protein 13, G protein-coupled receptor | | |
| | 136 | | |
| OPRD1 | OPRD, delta opioid receptor | opioid | 4985 |
| OPRK1 | KOR, OPRK, KOP, kappa opioid receptor | opioid | 4986 |
| OPRL1 | OOR, ORL1, KOR-3, NOCIR, MGC34578, opiate | opioid | 4987 |
| | receptor-like 1 | | |
| OPRM1 | OPRM, MOR-1, mu opioid receptor | opioid | 4988 |
| OXTR | oxytocin receptor | vasopressin | 5021 |
| P2RY1 | purinergic receptor P2Y1 | purinoceptor | 5028 |
| P2RY10 | P2Y10, G-protein coupled purinergic receptor P2Y10, | purinoceptor, | 27334 |
| | P2Y-like receptor, P2Y purinoceptor 10 | orphan A13 | |
| | | group | |
| P2RY11 | P2Y11, purinergic receptor P2Y11, P2Y purinoceptor 11 | purinoceptor | 5032 |
| P2RY12 | HORK3, P2Y12, ADPG-R, SP1999, P2T(AC), P2Y(AC), | purinoceptor, | 64805 |
| | P2Y(ADP), P2Y(cyc) | ADP/UDP- | |
| | | glucose | |
| P2RY13 | P2Y13, GPR94, SP174, GPR86 | ADP/UDP- | 53829 |
| | | glucose | |
| P2RY2 | P2U, HP2U, P2U1, P2UR, P2Y2, P2RU1, P2Y2R, | purinoceptor | 5029 |
| | MGC20088, MGC40010 | | |
| P2RY4 | NRU, P2P, UNR, P2Y4 | purinoceptor | 5030 |
| P2RY5 | P2Y5, P2Y purinoceptor 5, purinergic receptor 5, RB | purinoceptor, | 10161 |
| | intron encoded G-protein coupled receptor, G-protein | orphan A12 | |
| | coupled purinergic receptor P2Y5 | group | |
| P2RY6 | P2Y6, MGC15335, pyrimidinergic receptor P2Y6 | purinoceptor | 5031 |
| PNR | putative neurotransmitter receptor | trace amine | 9038 |
| PPYR1 | Y4, PP1, NPY4R, pancreatic polypeptide receptor 1 | neuropeptide Y | 5540 |
| PTAFR | platelet-activating factor receptor | | 5724 |
| PTGDR | DP, MGC49004, PGD receptor, prostanoid DP receptor, | prostanoid | 5729 |
| | prostaglandin D2 receptor | | |
| PTGER1 | prostaglandin E receptor 1, subtype EP1, EP1, | prostanoid | 5731 |
| | prostanoid EP1 receptor, PGE receptor, EP1 subtype | | |
| PTGER2 | EP2, prostaglandin E receptor 2 (subtype EP2), 53 kDa | prostanoid | 5732 |
| PTGER3 | EP3, MGC27302, prostanoid EP3 receptor, | prostanoid | 5733 |
| | prostaglandin E2 receptor | | |
| PTGER4 | EP4, EP4R, prostaglandin E receptor 4, subtype EP4, | prostanoid | 5734 |
| | prostaglandin E2 receptor | | |
| PTGFR | FP, MGC46203, prostaglandin F receptor, PGF | prostanoid | 5737 |
| | receptor, PGF2 alpha receptor, prostanoid FP receptor, | | |
| | prostaglandin F2 alpha receptor, prostaglandin receptor | | |
| | (2-alpha) | | |
| PTGIR | IP, PRIPR, prostaglandin I2 (prostacyclin) receptor (IP), | prostanoid | 5739 |
| | PGI receptor, prostacyclin receptor, prostanoid IP | | |
| | receptor | | |
| PTHR1 | PTHR, parathyroid hormone receptor 1 precursor, PTH | PTH | 5745 |
| | receptor, PTH/PTHr receptor, PTH/PTHrP receptor | | |
| PTHR2 | PTH2 receptor, parathyroid hormone receptor 2 | PTH | 5746 |
| | precursor | | |
| RAI3 | RAIG1, GPRC5A, retinoic acid induced 3 | | 9052 |
| RGR | retinal G protein coupled receptor | opsin | 5995 |
| RRH | peropsin, retinal pigment epithelium-derived rhodopsin | opsin | 10692 |
| | homolog | | |
| SALPR | G-protein coupled receptor SALPR, somatostatin and | Orphan A10 | 51289 |
| | angiotensin-like peptide receptor, GPCR135 | group | |
| SCTR | SR, pancreatic secretin receptor, secretin receptor | glucagon-VIP- | 6344 |
| | precursor | secretin | |
| SMO | SMOH, Gx | | 6608 |
| SREB3 | super conserved receptor expressed in brain 3 | SREB | 54328 |
| SSTR1 | SRIF-2, G-protein coupled receptor | somatostatin | 6751 |
| | somatostatin receptor isoform 1, somatostatin receptor 1 | | |
| SSTR2 | somatostatin receptor 2 | somatostatin | 6752 |
| SSTR3 | somatostatin receptor 3 | somatostatin | 6753 |
| SSTR4 | somatostatin receptor 4 | somatostatin | 6754 |
| SSTR5 | somatostatin receptor 5 | somatostatin | 6755 |
| TACR1 | SPR, NK1R, NKIR, TAC1R | tachykinin | 6869 |
| TACR2 | SKR, NK2R, NKNAR, TAC2R, NK-2 receptor | tachykinin | 6865 |
| TACR3 | NK3R, TAC3RL, NK-3 receptor, neurokinin B receptor | tachykinin | 6870 |
| TAR1 | TA1, trace amine receptor 1 | trace amine | 134864 |
| TAR3 | TA3, trace amine receptor 3 | trace amine | 134860 |
| TAR4 | TA4 | trace amine | 319100 |
| TAR5 | TA5, TRAR5, GPR102 | trace amine | 83551 |
| TBXA2R | thromboxane A2 receptor isoform 2 | | 6915 |
| TG1019 | 5-oxo-ETE G-protein coupled receptor | | 165140 |
| TM7SF1 | transmembrane 7 superfamily member 1 (upregulated in | | 7107 |
| | kidney) | | |
| TPRA40 | transmembrane domain protein regulated in adipocytes | | 131601 |
| | 40 kDa | | |
| TRAR4 | TA4 | trace amine | 319100 |
| TRHR | thyrotropin-releasing hormone receptor | | 7201 |
| TSHR | LGR3, thyroid stimulating hormone receptor, thyrotropin | Hormone | 7253 |
| | receptor | | |
| UTS2R | UTR, UTR2, GPR14 | urotensin | 2837 |
| VIPR1 | II, HVR1, RCD1, RDC1, VIPR, VIRG, VPAC1, PACAP- | VIP | 7433 |
| | R-2, VIP receptor, type I | | |
| | PACAP type II receptor | | |
| | pituitary adenylate cyclase activating polypeptide | | |
| | receptor, type II | | |
| VIPR2 | vasoactive intestinal peptide receptor 2 | VIP | 7434 |
| XCR1 | GPR5, CCXCR1, lymphotactin receptor, G protein- | chemokine | 2829 |
| | coupled receptor 5 | | |

### Example 31

The experiments described herein demonstrate that the invention can be used to assess the selective activity of chemical compounds, eg. pharmaceutical compounds, on different receptors or, more generally, on the interactions of specific pairs of test proteins.

It is known that certain compounds selectively activate or inhibit the beta class of adrenergic receptors, or the alpha class. For example, isoproterenol is known as a beta adrenergic-selective agonist, whereas UK14,304 is known to be a selective agonist of alpha adrenergic receptors. In parallel, alprenolol is a beta-selective antagonist, and yohimbine antagonizes alpha class receptors, selectively.

A series of 5 GPCRs was tested, i.e., ADRB1, ADRB2, ADRA2A, ADRA2B, and ARDA2C.

In a first set of experiments, the two agonists were tested, in accordance with the methodologies set forth in the prior examples, using varying concentrations of agonist and the responses of the transfected cells evaluated.

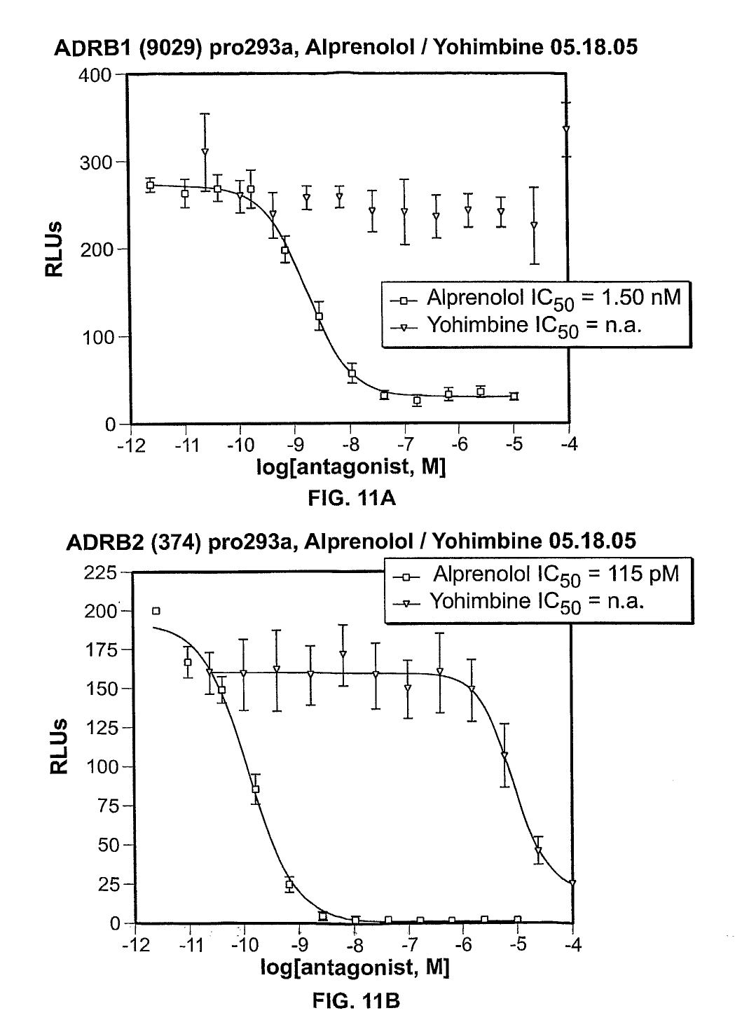

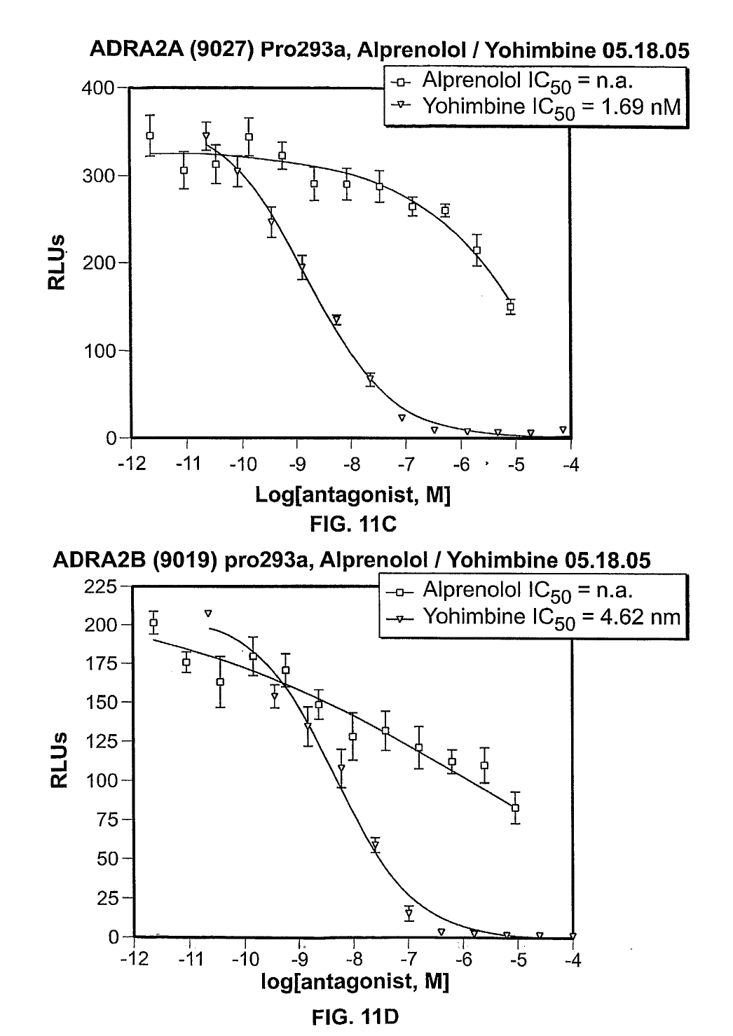

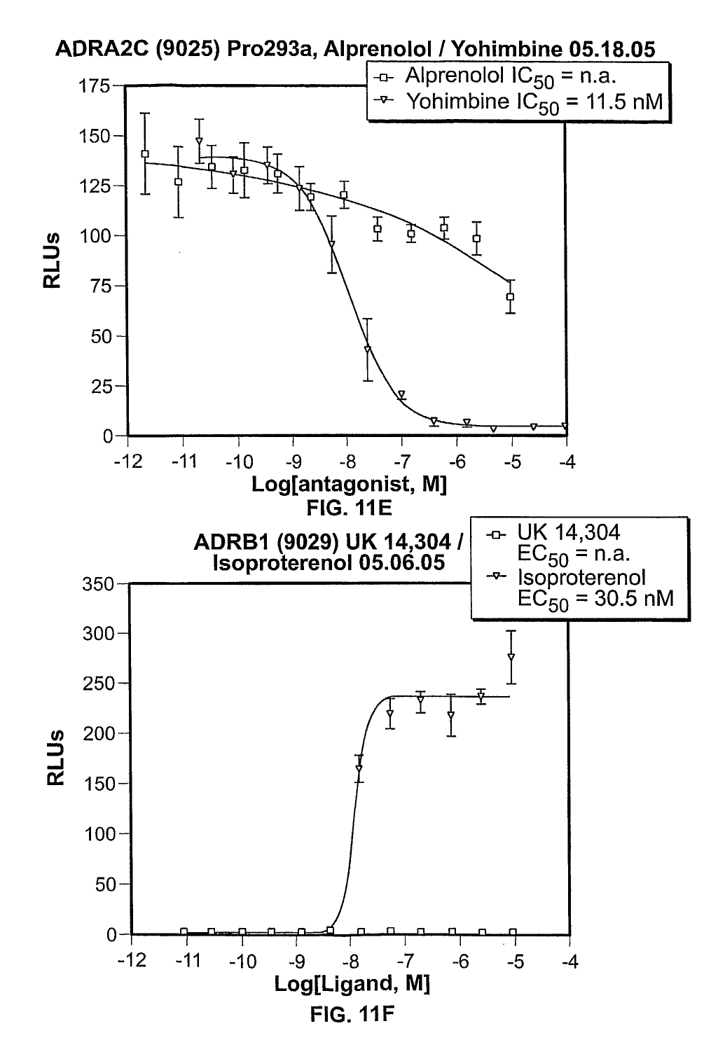

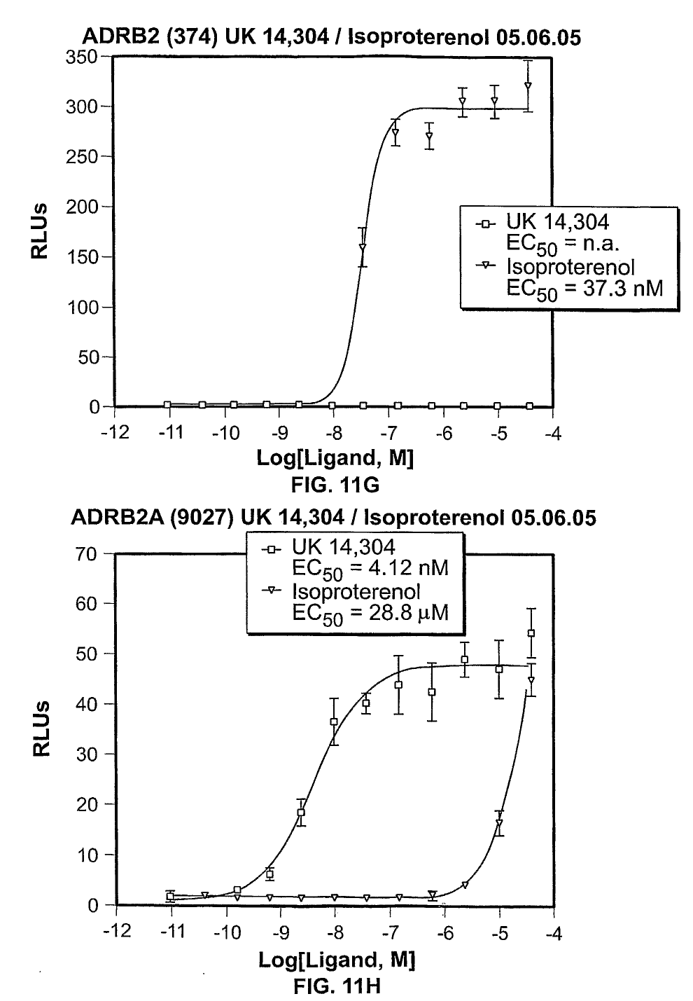

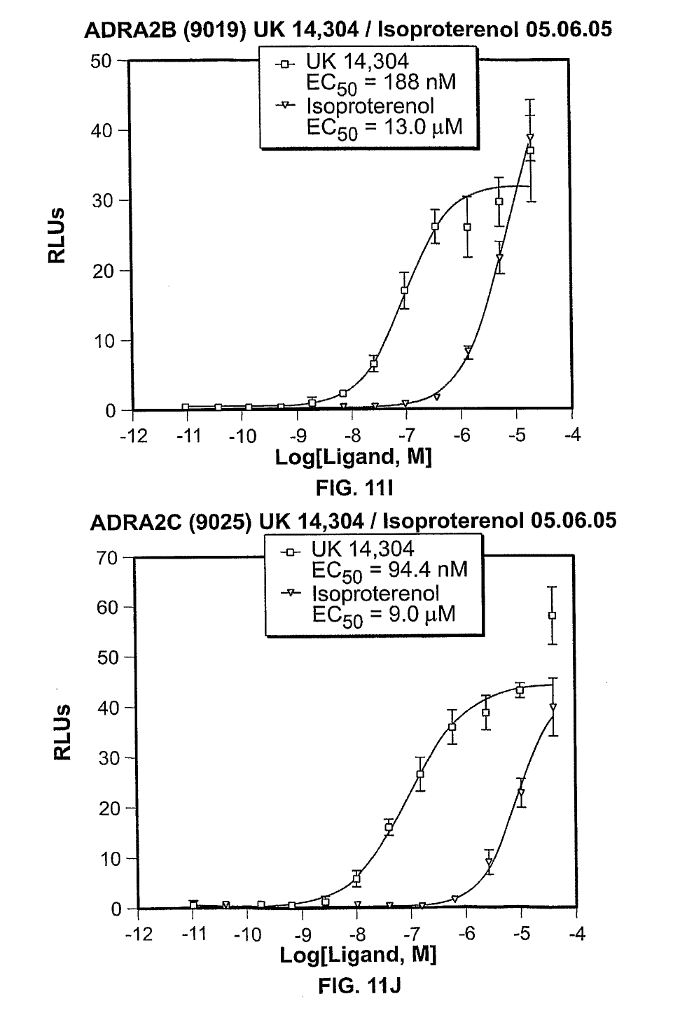

FIGS. 11A-E present these data. It will be seen that for both ADRB1 (FIG. 11A) and ADRB2 (FIG. 11B), the EC₅₀ for isoproterenol was determined to be 30.5 nM and 37.3 nM respectively, while UK14,304 had no effect on these receptors at any concentration used.

In contrast, ADRA2A, ADRA2B and ADRA2C, were found to respond to much lower concentration of UK14,304 than isoproterenol.

A parallel set of experiments using the two antagonists was carried out, and these results are shown in FIGS. 11F to 11J. It will be seen from, e.g., FIGS. 11F and 11G, that responses of both ADRB1 and ADRB2 were markedly inhibited by the beta-selective antagonist alprenolol, whereas the alpha-selective antagonist yohimbine had no effect, or in the case of ADRB2, showed inhibition at only the very highest concentrations tested. In contrast, when the alpha class receptors ADRA2A, ADRA2B and ADRA2C were evaluated, the alpha-selective antagonist yohimbine yielded an IC₅₀ value in the low nanomolar range, while alprenolol had only a modest inhibitory effect at the highest concentrations tested. These data confirm the identity of isoproterenol and UK14,304 as beta adrenergic- and alpha adrenergic-selective agonists, respectively, and alprenolol and yohimbine as beta- and alpha-selective antagonists, respectively.

Other features of the invention will be clear to the skilled artisan and need not be reiterated here.

We claim:

1. A multiplex array useful in determining activity of a plurality of test proteins comprising:
a solid substrate having a plurality of receptacles, each of which contains a sample of cells, transformed or transfected with
(a) a first nucleic acid molecule comprising:
(i) a nucleotide sequence which encodes a first test protein,
(ii) a nucleotide sequence encoding a cleavage site for a protease, and
(iii) a nucleotide sequence which encodes a protein which activates a reporter gene in said cell,
(b) a second nucleic acid molecule which comprises:
(i) a nucleotide sequence which encodes a second test protein whose interaction with said first test protein in the presence of said test compound of interest is to be measured,
(ii) a nucleotide sequence which encodes a protease or a protease which is specific for said cleavage site,
wherein said first test protein differs from other first test proteins in each of said plurality of samples, wherein activity of said reporter gene is used to determine activity of one or more of said test proteins.

2. The multiplex array of claim 1, wherein each of said first test protein is a receptor.

3. The multiplex array of claim 2, wherein at least one of said first test proteins is a GPCR.

4. The multiplex array of claim 2, wherein each of said first test proteins is a GPCR.

5. The multiplex array of claim 2 where each of said first test proteins is a GPCR and each of said second test proteins is an arrestin.

6. The multiplex array of claim 1, comprising from about 25 to about 200 samples of cells, each of which is transformed or transfected with a different first test protein.

7. The multiplex array of claim 6, comprising from about 50 to about 200 samples of cells.

8. The multiplex array of claim 7, comprising from about 50 to about 100 samples of cells.

9. The multiplex array of claim 1, where at least a plurality of said first test proteins are selected from Table 1.

10. The multiplex array of claim 9, wherein at least a plurality of said first test proteins are selected from Table 2.

11. The multiplex array of claim 10, wherein said multiplex array comprises a plurality of test samples which express all of the first test proteins of Table 2.
